(19) United States
(12) Patent Application Publication
(10) Pub. No.: US 2026/0040223 A1
(43) Pub. Date: Feb. 5, 2026

(54) METHODS FOR HANDLING FALSE ALARM TRIGGERED MISS-DETECTIONS FOR LP-WURS

(71) Applicant: Huawei Technologies Co., Ltd., Shenzhen (CN)

(72) Inventors: Hussain Elkotby, Belmont, MA (US); Weimin Xiao, Hoffman Estates, IL (US)

(21) Appl. No.: 19/301,471

(22) Filed: Aug. 15, 2025

Related U.S. Application Data
(63) Continuation of application No. PCT/US2024/016152, filed on Feb. 16, 2024.
(60) Provisional application No. 63/485,407, filed on Feb. 16, 2023.
(60) Provisional application No. 63/518,428, filed on Aug. 9, 2023.

(51) Int. Cl. H04W 52/02

(52) U.S. Cl. CPC H04W 52/0235

(57) ABSTRACT

Various aspects of the present disclosure generally relate to wireless communication. In some aspects, a method implemented in a wireless device includes receiving configuration information from a network device, wherein the configuration information comprises a parameter for a low power wake-up signal (LP-WUS) with a first modulation format, and wherein the configuration information further comprises a monitoring duration. The method also includes monitoring for the low power wake-up signal (LP-WUS) transmitted. The method also includes responsive to detecting a first LP-WUS, monitoring for transmissions of signals with a second modulation format. The method also includes stopping monitoring for the signals with the second modulation format when the device is unable to receive the signals with the second modulation format within the monitoring duration.

### PRIORITY CLAIM AND CROSS-REFERENCE

This patent application is a continuation of International Application No. PCT/US2024/016152, filed on Feb. 16, 2024 and entitled “Methods for Handling False Alarm Triggered Miss-Detections for LP-WURS,” which claims priority to U.S. Provisional Application No. 63/485,407, filed on Feb. 16, 2023 and entitled “Methods for Handling False Alarm Triggered Miss-Detections For LP-WURS” and to U.S. Provisional Application No. 63/518,428, filed on Aug. 9, 2023 and entitled “Methods on LP-WUS Monitoring Activation and Deactivation,” applications of which are hereby incorporated by reference herein as if reproduced in their entireties.

### TECHNICAL FIELD

The present disclosure relates generally to methods and apparatus for wireless communications, and, in particular embodiments, to methods and apparatus for handling false alarm triggered miss-detections.

### BACKGROUND

A Study item on low-power wake-up signal (LP-WUS) and low-power wake-up receiver (LP-WUR) for new radio (NR) was approved in 3GPP RAN #94e meeting and revised in RAN #97e. This study covers low-power receiver architectures, signal and protocol design, and evaluation methodology targeting metrics such as power saving gain, latency, coverage availability, coexistence with non-low-power-WUR UEs, and network resource overhead. Few types of receiver architectures, supporting On-Off Keying (OOK) modulation scheme, were agreed in RAN1 #110bis-e including architectures with RF envelope detection, heterodyne architectures with IF envelope detection, and homodyne/zero-IF architectures with baseband (BB) envelope detection. These architectures may also be suitable for other modulation schemes such as Frequency Shift Keying (FSK).

### SUMMARY

In accordance with an embodiment, a method implemented in a wireless device includes receiving configuration information from a network device, wherein the configuration information comprises a parameter for a low power wake-up signal (LP-WUS) with a first modulation format, and wherein the configuration information further comprises a monitoring duration. The method also includes monitoring for the low power wake-up signal (LP-WUS) transmitted. The method also includes responsive to detecting a first LP-WUS, monitoring for transmissions of signals with a second modulation format. The method also includes stopping monitoring for the signals with the second modulation format when the device is unable to receive the signals with the second modulation format within the monitoring duration.

In an embodiment, the first modulation format includes one of frequency shift keying (FSK) or on-off keying (OOK). In an embodiment, the second modulation format includes one of: binary phased shift keying (BPSK); quadrature phase shift keying (QPSK); 4-quadrature amplitude modulation (4-QAM); 16-QAM; 64-QAM; 256-QAM; or Zadoff-Chu modulation. In an embodiment, the parameter further comprises at least one of bandwidth, data rate, or symbol rate. In an embodiment, the wireless device resumes monitoring for the LP-WUS when the device is unable to receive the signals with the second modulation format within the monitoring duration. In an embodiment, responsive to detecting the first LP-WUS from the network device, the wireless device sets a timer, wherein upon expiry of the timer, the wireless device resumes monitoring for the LP-WUS is the wireless device did not receive a signal with the second modulation format that is associated with the wireless device. In an embodiment, the first modulation format is different from the second modulation format.

In accordance with an embodiment, a method implemented in a base station includes transmitting configuration information to a wireless device, wherein the configuration information includes a parameter for a low power wake-up signal (LP-WUS) with a first modulation format, and wherein the configuration information further includes a monitoring duration. The method also includes transmitting the LP-WUS to the wireless device. The method also includes transmitting a signal with the second modulation format to the wireless device during the monitoring duration.

In an embodiment, the first modulation format includes one of frequency shift keying (FSK) or on-off keying (OOK). In an embodiment, the second modulation format includes one of: binary phased shift keying (BPSK); quadrature phase shift keying (QPSK); 4-quadrature amplitude modulation (4-QAM); 16-QAM; 64-QAM; 256-QAM; or Zadoff-Chu modulation. In an embodiment, the parameter further comprises at least one of bandwidth, data rate, or symbol rate.

In accordance with an embodiment, a method implemented in a wireless device includes receiving configuration information from a network device, wherein the wireless device comprises a main radio and a low power wake-up receiver (LP-WUR), and wherein the configuration information comprises a main radio monitoring duration. The method also includes monitoring, by the LP-WUR, for a low power wake-up signal (LP-WUS) from the network device. The method also includes responsive to detecting a first LP-WUS from the network device, signaling a wake-up indication to the main radio to change a power state of the main radio from a first power state to a second power state. The method also includes utilizing the main radio to monitor for signals from the network device after the main radio has transitioned to the second power state. The method also includes transitioning the main radio back to the first power state after an expiration of the main radio monitoring duration if the main radio fails to receive a signal from the network device during the main radio monitoring duration indicating that the main radio should remain in the second power state.

In an embodiment, the configuration information further includes an offset time. The LP-WUS includes a first LP-WUS and the offset time is a time for the main radio to transition from the first power state to the second power state. The method further includes, after detecting the first LP-WUS, continuing to monitor by the LP-WUR, for a second LP-WUS for at least a duration of the offset.

In an embodiment, the method also includes configuring a first timer equal to the offset time and a second timer equal to a sum of the offset time and the main radio monitoring duration. The method also includes, responsive to detecting, by the LP-WUS, the first LP-WUR, initializing the first timer and the second timer. The method also continues to monitor, with the LP-WUS, for the second LP-WUR for at least the duration of the first timer. The method also monitors, by the main radio, for signals from the network device at the expiry of the first timer until at least the expiry of the second timer.

In an embodiment, the method also includes, responsive to detecting the second LP-WUS by the LP-WUR before expiry of the first timer, resetting the second timer. In an embodiment, the method also includes utilizing the configuration information for at least one of measurements of the LP-WUR or a periodic synchronization of the LP-WUR. In an embodiment, the method also includes utilizing the LP-WUR to monitor for the LP-WUS continuously or monitor for the LP-WUS according to a received duty cycle based on the configuration information. In an embodiment, the configuration information includes support indication of a continuous monitoring mode which alleviates a network requirement to transmit periodic reference signals. In an embodiment, the configuration information comprises a first offset indicating a minimum duration between LP-WUS transmission and a first main radio signaling opportunity. In an embodiment, the configuration information includes a second offset indicating a maximum duration between LP-WUS transmission and a first main radio signaling opportunity and further comprising operating the main radio in the second power state at an end of the second offset. In an embodiment, the configuration information includes a minimum duration required for the main radio to monitor for LP-WUS triggered signals. In an embodiment, the configuration information includes at least one of a data rate, a coding scheme, a coding rate, or a synchronizing/triggering preamble. In an embodiment, the method further includes reporting capabilities of the wireless device to the network device. In an embodiment, the first power state comprises a sleep state. In an embodiment, the second power state comprises an active state.

In accordance with an embodiment, a method implemented in a base station transmitting configuration information to a wireless device, wherein the configuration information comprises an offset time and a main radio monitoring duration. The method also includes transmitting a low power wake-up signal (LP-WUS) to the wireless device. The method also includes transmitting data to the wireless device after expiry of the offset time and before expiry of a time equal to a sum of the offset time and the main radio monitoring duration.

In an embodiment, the configuration information comprises support indication of a continuous monitoring mode which alleviates a network requirement to transmit periodic reference signals. In an embodiment, the configuration information comprises a first offset indicating a minimum duration between LP-WUS transmission and a first main radio signaling opportunity. In an embodiment, the configuration information comprises a second offset indicating a maximum duration between LP-WUS transmission and a first main radio signaling opportunity and further comprising operating the main radio in the second power state at an end of the second offset. In an embodiment, the configuration information comprises a minimum duration required for the main radio to monitor for LP-WUS triggered signals. In an embodiment, the configuration information comprises at least one of a data rate, a coding scheme, a coding rate, or a synchronizing/triggering preamble. In an embodiment, the method further includes receiving a report of capabilities of the wireless device from the wireless device.

In accordance with an embodiment, a method implemented in a wireless device includes receiving, from a network device, configuration of a first receiver mode of the wireless device, the configuration indicating a monitoring mode and a time offset. The method also includes detecting a first signal using the first receiver mode of the wireless device. The method also includes initializing a first timer and a second timer based on the first signal and the time offset. The method also includes operating a second receiver mode in a first power state and utilizing the second receiver type to monitor signals at an expiry of the first timer. The method also includes operating the second receiver type in a second power state at an expiry of the second timer.

In an embodiment, the method also includes monitoring signals by the second receiver type upon being operated in the first power state for a time duration indicated by the configuration. In an embodiment, the operating the second receiver type in the second power state is at an end of an aggregate duration of the time offset and the second time duration.

In an embodiment, the wireless device further initializes a third timer based on the first signal and the first time duration, wherein the third timer starts at the detection of the first signal. The method also includes detecting a second signal using the first receiver type. The method also includes, on a condition that the second signal is detected before third expiry of the third timer, performing at least one of sending a wake-up indication to the second receiver type, or resetting the second timer.

In an embodiment, the method also includes sending a wake-up indication to the second receiver type in response to the receiving the first signal. In an embodiment, the method also includes resetting the second timer in response to the receiving the first signal. In an embodiment, the first signal and the second signal are low power wake-up signals. In an embodiment, the first receiver type is of a low power wake-up receiver. In an embodiment, the second receiver type is of a receiver in a main radio, the main radio includes a wireless transmit unit. In an embodiment, the signals monitored by the second receiver type are paging downlink control information (DCI) signals sent over a physical downlink control channel (PDCCH). In an embodiment, the second receiver type are operable in a plurality of power states, the first power state of the plurality of power states representing turning on of the second receiver type, and the second power state of the plurality of power states representing turning off of the second receiver type. In an embodiment, the method also includes transmitting a third signal after the first expiry of the first timer using the wireless transmit unit of the main radio. In an embodiment, the third signal is an indication of detection of the first signal. In an embodiment, the method also includes receiving, using the second receiver type, a signal triggering power state transition and operating the second receiver type in the second power state. In an embodiment, the signal triggering the power state transition is a go-to-sleep indication to the second receiver type. In an embodiment, the method also includes receiving, using the second receiver type, at least one of a fourth signal or a fifth signal before the second expiry of the second timer. In an embodiment, the fourth signal is any of a confirmation of transmission of the first signal or an indication for the second receiver type to monitor the signals. In an embodiment, the fifth signal is any of a paging DCI, a paging message, a DCI scrambled by a cell radio network temporary identifier (C-RNTI), a short message, or system information.

In accordance with an embodiment, an apparatus includes at least one processor; and a non-transitory memory storing programming instructions that, when executed by the at least one processor, cause the system to perform any of the methods described above.

In accordance with an embodiment, a non-transitory computer readable storage medium includes instructions that when executed by a processor cause the processor to perform any of the methods described above.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 shows an example protocol flow/timeline based on DRX Configuration in accordance with an embodiment;

FIG. 2 is an example protocol flow/timeline based on eDRX (T_{eDRX}>1024 frame) configuration in accordance with an embodiment;

FIG. 3 is an example protocol flow/timeline based on LP-WUS configuration with UE Addressing in accordance with an embodiment;

FIG. 4 is an example protocol flow/timeline based on LP-WUS configuration with UE group addressing in accordance with an embodiment;

FIG. 5 shows a survey of low-power receiver architectures in accordance with an embodiment;

FIG. 6 shows a basic block diagram for RF envelope detection receiver architecture in accordance with an embodiment;

FIG. 7 shows an example of synchronized switching/double-sampling receiver architecture in accordance with an embodiment;

FIG. 8 shows an example of a 2-tone reception envelope detection receiver architecture in accordance with an embodiment;

FIG. 9 shows a basic block diagram for IF envelope detection receiver architecture in accordance with an embodiment;

FIG. 10 shows a basic block diagram for BB envelope detection receiver architecture in accordance with an embodiment;

FIG. 11 shows an example of sub-sampling receiver architecture in accordance with an embodiment;

FIG. 12 shows an example of uncertain IF receiver architecture in accordance with an embodiment;

FIG. 13 shows a representation of the dual uncertain-IF receiver architecture in accordance with an embodiment;

FIG. 14 shows an example 1-bit FSK receiver architecture utilizing parallel OOK receivers in accordance with an embodiment;

FIG. 15 shows an example FSK receiver architecture utilizing analog domain FM-to-AM detector in accordance with an embodiment;

FIG. 16 shows an example FSK receiver architecture utilizing analog Domain FM-to-AM detector in accordance with an embodiment;

FIG. 17 shows an example 1-bit FSK receiver architecture utilizing parallel IF envelope detector based OOK receivers in accordance with an embodiment;

FIG. 18 shows an example 2-bit FSK receiver architecture utilizing parallel OOK receivers in accordance with an embodiment;

FIG. 19 shows a wireless system for low power wakeup signaling in accordance with an embodiment;

FIG. 20 is a message flow diagram of a method for waking up a sleeping UE using a LP WUS in accordance with an example embodiment;

FIG. 21 shows a main radio and LP-WUR processing timeline in the presence of false alarms due to noise/interference in accordance with an embodiment;

FIG. 22 shows a dual LP-WUR and Main Radio Operation timeline in the presence of noise/interference false alarms in accordance with an embodiment;

FIG. 23A is a message flow diagram of a method for waking up a sleeping UE using a LP WUS in accordance with an example embodiment;

FIG. 23B is a message flow diagram of a method for waking up a sleeping UE using a LP WUS in accordance with an example embodiment;

FIG. 24A is a message flow diagram of a method for waking up a sleeping UE using a LP WUS in accordance with an example embodiment;

FIG. 24B is a message flow diagram of a method for waking up a sleeping UE using a LP WUS in accordance with an example embodiment;

FIG. 25 shows a repetitive LP-WUS transmission operation in the presence of noise/interference false alarms in accordance with an embodiment;

FIG. 26 shows a limited LP-WUR duty-cycle operation in the presence of noise/interference false alarms in accordance with an embodiment;

FIG. 27 shows an example flow chart of a method illustrating a UE utilizing a LP-WUR to monitor for LP-WUS concurrently while main radio is operating in accordance with an embodiment;

FIG. 28 shows an example flow chart illustrating a UE utilizing a LP-WUR to monitor for LP-WUS concurrently while main radio ramps-up and synchronizes for reception of LP-WUS triggered signals in accordance with an embodiment;

FIG. 29 shows another example flow chart illustrating a UE utilizing a LP-WUR to continuously monitor for LP-WUS concurrently while main radio ramps-up and/or synchronizes for reception of LP-WUS triggered signals in accordance with an embodiment;

FIG. 30 illustrates an example communications system in accordance with an embodiment;

FIG. 31 illustrates an example communication system in accordance with an embodiment;

FIGS. 32A and 32B illustrate example devices that may implement the methods and teachings according to this disclosure; and

FIG. 33 is a block diagram of a computing system that may be used for implementing the devices and methods disclosed herein.

Corresponding numerals and symbols in the different figures generally refer to corresponding parts unless otherwise indicated. The figures. are drawn to clearly illustrate the relevant aspects of the embodiments and are not necessarily drawn to scale.

### DETAILED DESCRIPTION

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

The low power of WUR with simple envelope detection can allow its operation in “continuous” or short “duty-cycled” monitoring modes resulting in an increase in false alarms/wake-ups. Long transition time for the main radio without LP-WUS monitoring can result in non-negligible probability of LP-WUS miss detections. Disclosed herein are procedures that target reducing the impact of false alarm triggered miss-detections for LP-WURs when operating in ‘continuous’ or short ‘duty-cycled’ monitoring modes, either in the RRC IDLE/INACTIVE or RRC CONNECTED states. Further, procedures to handle activation/deactivation of LP-WUS monitoring are provided. The disclosed methods, systems, and apparatuses provide mechanisms for handling LP-WUS false alarm triggered miss-detection with a proper trade-off between UE power consumption, experienced latency, and network resource overhead.

Various embodiments of communication systems will now be presented with reference to various apparatuses and methods. These apparatuses and methods will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

This disclosure describes existing 3GPP power saving schemes, and the power saving scheme based on LP-WUS/LP-WUR. Further, an overview of existing low-power receiver architectures in literature and as discussed in 3GPP RAN1 meetings is described.

Disclosed herein are methods, systems, and apparatus for handling false alarm triggered miss-detections for LP-WURS.

In various embodiments, a method implemented in a wireless transmit/receive unit (WTRU) includes receiving, from a network device, configuration of a first receiver type of the WTRU, the configuration indicating a monitoring mode and a time offset. The method also includes detecting a first signal using the first receiver type of the wireless device. The method also includes initializing a first timer and a second timer based on the first signal and the time offset. The method also includes operating the second receiver type in a first power state and utilizing the second receiver type to monitor signals at first expiry of the first timer. The method also includes operating the second receiver type in a second power state at second expiry of the second timer.

Some embodiments of the disclosure provide for monitoring signals by the second receiver type upon being operated in the first power state for a time duration indicated by the configuration. Some embodiments of the disclosure provide that the wireless device further initializes a third timer based on the first signal and the time duration, wherein the third timer starts at the expiry of the first timer. In an embodiment, the operating the second receiver type in the second power state is at an end of an aggregate duration of the time offset and the time duration and wherein the operating the second receiver type in the second power state starts at an expiry of the third timer. Some embodiments of the disclosure provide that the method may also include detecting a second signal using the first receiver type and, on a condition that the second signal is detected before third expiry of the third timer, sending a second indication to the second receiver type. Some embodiments of the disclosure provide that the first indication and the second indication are wake-up indications to the second receiver type. Some embodiments of the disclosure provide that the first indication and the second indication are used to reset the second timer. Some embodiments of the disclosure provide that the first signal and the second signal are low power wake-up signals. Some embodiments of the disclosure provide that the first receiver type is of a low power wake-up receiver. Some embodiments of the disclosure provide that the second receiver type is of a receiver in a main radio, the main radio comprising a wireless transmit unit. Some embodiments of the disclosure provide that the signals monitored by the second receiver type are paging Downlink Control Information (DCI) signals sent over a Physical Downlink Control Channel (PDCCH). Some embodiments of the disclosure provide that the second receiver type are operable in a plurality of power states, the first power state of the plurality of power states representing turning on of the second receiver type, and the second power state of the plurality of power states representing turning off of the second receiver type.

In various embodiments, a method implemented in a wireless device includes receiving configuration information from a network device, wherein the configuration information includes an offset and a main radio monitoring duration. The method also includes configuring a first timer and a second timer according to the configuration information received from the network device. The method also includes configuring a third timer according to the main radio monitoring duration, wherein the wireless device comprises a main radio and a low power wake-up receiver (LP-WUR). The method also includes monitoring, by the LP-WUR, for a low power wake-up signal (LP-WUS) from the network device. The method also includes responsive to detecting a first LP-WUS from the network device, signaling a wake-up indication to the main radio and initializing the first timer, the second timer, and the third timer. The method also includes utilizing, when the third timer has not expired, the main radio to monitor for LP-WUS triggered signals at a first expiry of the first timer until one of second expiry of the second timer or end of a time period determined according to a sum of the offset and the main radio monitoring duration.

Some embodiments of the disclosure provide utilizing the configuration information for at least one of measurements of the LP-WUR or a periodic synchronization of the LP-WUR. Some embodiments of the disclosure provide utilizing the LP-WUR to monitor for the LP-WUS continuously or monitor for the LP-WUS according to a received duty cycle based on the configuration information. Some embodiments of the disclosure provide that the configuration information includes support indication of a continuous monitoring mode which alleviates a network requirement to transmit periodic reference signals. Some embodiments of the disclosure provide that the configuration information includes a first offset indicating a minimum duration between LP-WUS transmission and a first main radio signaling opportunity. Some embodiments of the disclosure provide that the configuration information includes a second offset indicating a maximum duration between LP-WUS transmission and a first main radio signaling opportunity. Some embodiments of the disclosure provide that the configuration information includes a minimum duration required for the main radio to monitor for LP-WUS triggered signals. Some embodiments of the disclosure provide that the configuration information includes at least one of a data rate, a coding scheme, a coding rate, or a synchronizing/triggering preamble. Some embodiments of the disclosure provide reporting capabilities of the wireless device to the network device.

In accordance with an embodiment, a method implemented in a wireless device includes receiving configuration information from a network device, wherein the configuration information comprises a parameter for a low power wake-up signal (LP-WUS) with a first modulation format, and wherein the configuration information further comprises a monitoring duration. The method also includes monitoring for the low power wake-up signal (LP-WUS) transmitted. The method also includes responsive to detecting a first LP-WUS, monitoring for transmissions of signals with a second modulation format. The method also includes stopping monitoring for the signals with the second modulation format when the device is unable to receive the signals with the second modulation format within the monitoring duration.

In an embodiment, the first modulation format includes one of frequency shift keying (FSK) or on-off keying (OOK). In an embodiment, the second modulation format includes one of: binary phased shift keying (BPSK); quadrature phase shift keying (QPSK); 4-quadrature amplitude modulation (4-QAM); 16-QAM; 64-QAM; 256-QAM; or Zadoff-Chu modulation. In an embodiment, the parameter further comprises at least one of bandwidth, data rate, or symbol rate. In an embodiment, the wireless device resumes monitoring for the LP-WUS when the device is unable to receive the signals with the second modulation format within the monitoring duration. In an embodiment, responsive to detecting the first LP-WUS from the network device, the wireless device sets a timer, wherein upon expiry of the timer, the wireless device resumes monitoring for the LP-WUS is the wireless device did not receive a signal with the second modulation format that is associated with the wireless device. In an embodiment, the first modulation format is different from the second modulation format.

In accordance with an embodiment, a method implemented in a base station includes transmitting configuration information to a wireless device, wherein the configuration information includes a parameter for a low power wake-up signal (LP-WUS) with a first modulation format, and wherein the configuration information further includes a monitoring duration. The method also includes transmitting the LP-WUS to the wireless device. The method also includes transmitting a signal with the second modulation format to the wireless device during the monitoring duration.

In an embodiment, the first modulation format includes one of frequency shift keying (FSK) or on-off keying (OOK). In an embodiment, the second modulation format includes one of: binary phased shift keying (BPSK); quadrature phase shift keying (QPSK); 4-quadrature amplitude modulation (4-QAM); 16-QAM; 64-QAM; 256-QAM; or Zadoff-Chu modulation. In an embodiment, the parameter further comprises at least one of bandwidth, data rate, or symbol rate.

In accordance with an embodiment, a method implemented in a wireless device includes receiving configuration information from a network device, wherein the wireless device comprises a main radio and a low power wake-up receiver (LP-WUR), and wherein the configuration information comprises a main radio monitoring duration. The method also includes monitoring, by the LP-WUR, for a low power wake-up signal (LP-WUS) from the network device. The method also includes responsive to detecting a first LP-WUS from the network device, signaling a wake-up indication to the main radio to change a power state of the main radio from a first power state to a second power state. The method also includes utilizing the main radio to monitor for signals from the network device after the main radio has transitioned to the second power state. The method also includes transitioning the main radio back to the first power state after an expiration of the main radio monitoring duration if the main radio fails to receive a signal from the network device during the main radio monitoring duration indicating that the main radio should remain in the second power state.

In an embodiment, the configuration information further includes an offset time. The LP-WUS includes a first LP-WUS and the offset time is a time for the main radio to transition from the first power state to the second power state. The method further includes, after detecting the first LP-WUS, continuing to monitor by the LP-WUR, for a second LP-WUS for at least a duration of the offset.

In an embodiment, the method also includes configuring a first timer equal to the offset time and a second timer equal to a sum of the offset time and the main radio monitoring duration. The method also includes, responsive to detecting, by the LP-WUS, the first LP-WUR, initializing the first timer and the second timer. The method also continues to monitor, with the LP-WUS, for the second LP-WUR for at least the duration of the first timer. The method also monitors, by the main radio, for signals from the network device at the expiry of the first timer until at least the expiry of the second timer.

In an embodiment, the method also includes, responsive to detecting the second LP-WUS by the LP-WUR before expiry of the first timer, resetting the second timer. In an embodiment, the method also includes utilizing the configuration information for at least one of measurements of the LP-WUR or a periodic synchronization of the LP-WUR. In an embodiment, the method also includes utilizing the LP-WUR to monitor for the LP-WUS continuously or monitor for the LP-WUS according to a received duty cycle based on the configuration information. In an embodiment, the configuration information includes support indication of a continuous monitoring mode which alleviates a network requirement to transmit periodic reference signals. In an embodiment, the configuration information comprises a first offset indicating a minimum duration between LP-WUS transmission and a first main radio signaling opportunity. In an embodiment, the configuration information includes a second offset indicating a maximum duration between LP-WUS transmission and a first main radio signaling opportunity and further comprising operating the main radio in the second power state at an end of the second offset. In an embodiment, the configuration information includes a minimum duration required for the main radio to monitor for LP-WUS triggered signals. In an embodiment, the configuration information includes at least one of a data rate, a coding scheme, a coding rate, or a synchronizing/triggering preamble. In an embodiment, the method further includes reporting capabilities of the wireless device to the network device. In an embodiment, the first power state comprises a sleep state. In an embodiment, the second power state comprises an active state.

In accordance with an embodiment, a method implemented in a base station transmitting configuration information to a wireless device, wherein the configuration information comprises an offset time and a main radio monitoring duration. The method also includes transmitting a low power wake-up signal (LP-WUS) to the wireless device. The method also includes transmitting data to the wireless device after expiry of the offset time and before expiry of a time equal to a sum of the offset time and the main radio monitoring duration.

In an embodiment, the configuration information comprises support indication of a continuous monitoring mode which alleviates a network requirement to transmit periodic reference signals. In an embodiment, the configuration information comprises a first offset indicating a minimum duration between LP-WUS transmission and a first main radio signaling opportunity. In an embodiment, the configuration information comprises a second offset indicating a maximum duration between LP-WUS transmission and a first main radio signaling opportunity and further comprising operating the main radio in the second power state at an end of the second offset. In an embodiment, the configuration information comprises a minimum duration required for the main radio to monitor for LP-WUS triggered signals. In an embodiment, the configuration information comprises at least one of a data rate, a coding scheme, a coding rate, or a synchronizing/triggering preamble. In an embodiment, the method further includes receiving a report of capabilities of the wireless device from the wireless device.

In accordance with an embodiment, a method implemented in a wireless device includes receiving, from a network device, configuration of a first receiver mode of the wireless device, the configuration indicating a monitoring mode and a time offset. The method also includes detecting a first signal using the first receiver mode of the wireless device. The method also includes initializing a first timer and a second timer based on the first signal and the time offset. The method also includes operating a second receiver mode in a first power state and utilizing the second receiver type to monitor signals at an expiry of the first timer. The method also includes operating the second receiver type in a second power state at an expiry of the second timer.

In an embodiment, the method also includes monitoring signals by the second receiver type upon being operated in the first power state for a time duration indicated by the configuration. In an embodiment, the operating the second receiver type in the second power state is at an end of an aggregate duration of the time offset and the second time duration.

In an embodiment, the wireless device further initializes a third timer based on the first signal and the first time duration, wherein the third timer starts at the detection of the first signal. The method also includes detecting a second signal using the first receiver type. The method also includes, on a condition that the second signal is detected before third expiry of the third timer, performing at least one of sending a wake-up indication to the second receiver type, or resetting the second timer.

In an embodiment, the method also includes sending a wake-up indication to the second receiver type in response to the receiving the first signal. In an embodiment, the method also includes resetting the second timer in response to the receiving the first signal. In an embodiment, the first signal and the second signal are low power wake-up signals. In an embodiment, the first receiver type is of a low power wake-up receiver. In an embodiment, the second receiver type is of a receiver in a main radio, the main radio includes a wireless transmit unit. In an embodiment, the signals monitored by the second receiver type are paging downlink control information (DCI) signals sent over a physical downlink control channel (PDCCH). In an embodiment, the second receiver type are operable in a plurality of power states, the first power state of the plurality of power states representing turning on of the second receiver type, and the second power state of the plurality of power states representing turning off of the second receiver type. In an embodiment, the method also includes transmitting a third signal after the first expiry of the first timer using the wireless transmit unit of the main radio. In an embodiment, the third signal is an indication of detection of the first signal. In an embodiment, the method also includes receiving, using the second receiver type, a signal triggering power state transition and operating the second receiver type in the second power state. In an embodiment, the signal triggering the power state transition is a go-to-sleep indication to the second receiver type. In an embodiment, the method also includes receiving, using the second receiver type, at least one of a fourth signal or a fifth signal before the second expiry of the second timer. In an embodiment, the fourth signal is any of a confirmation of transmission of the first signal or an indication for the second receiver type to monitor the signals. In an embodiment, the fifth signal is any of a paging DCI, a paging message, a DCI scrambled by a cell radio network temporary identifier (C-RNTI), a short message, or system information.

In various embodiments, an apparatus includes at least one processor; and a non-transitory memory storing programming instructions that, when executed by the at least one processor, cause the system to perform any of the methods described above.

In various embodiments, a non-transitory computer readable storage medium includes instructions that when executed by a processor cause the processor to perform any of the methods described above.

### 2.1 Power Saving Schemes Overview

The 3GPP standards specify the modulation formats of signals. For example, the resource elements (REs) within physical resource blocks on to which control channels and shared channels are often modulated with binary phased shift keying (BPSK), quadrature phase shift keying (QPSK)/4-QAM (quadrature amplitude modulation), 16-QAM, 64-QAM, and possibly 256-QAM. There are also references signals on the REs which may utilize a Zadoff-Chu modulation. The REs can be transformed in a waveform using an (inverse) fast Fourier transform (FFT) and/or a discrete Fourier transform (DFT) before transmission. With the introduction of a wakeup receiver, a second modulation format that is different than that described above can be used to generate a wakeup-signal. Examples of the second modulation format may include frequency shift keying (FSK) and on-off keying (OOK).

The network can provide (e.g., transmit to) a wireless device with a configuration of the wake-up signal. This configuration can include parameters, such as whether OOK or FSK is used, the bandwidth, the data rate, the symbol rate, etc. When the mobile device enables use of the WUR, the WUR is then monitoring for the WUS (first modulation format). The mobile device is no longer monitoring for the modulation formats (second modulation format) used for reference signals, control channels, shared channels. Upon detection of the WUS, the mobile device starts monitoring for the modulation formats used for reference signals, control channels, and shared channels for a configurable duration. For example, it may set a timer. Upon expiry of the time (or after the duration), the wireless device can resume monitoring for the WUS if it did not receive any control/shared channel associated with the wireless device. The association can include a RNTI.

Power saving schemes in 3GPP are discussed in Section 2.1.1 and utilization of LP-WUS and LP-WUR for power saving is discussed next in Section 2.1.2.

### 2.1.1 Power Saving Schemes in 3GPP

In 3GPP, duty-cycled operations in the form of Discontinuous Reception (DRX) and extended Discontinuous Reception (eDRX) are defined for power consumption reduction in NR RRC_IDLE and RRC_INACTIVE states through the reduction of the number of Paging Occasions (POs) monitored by the UE. Further power consumption reduction is achieved through Paging Early Indication (PEI) in NR RRC_IDLE and RRC_INACTIVE states, which is still subject to the duty-cycled operation. Similar power saving techniques are defined for NR RRC_CONNECTED state in the form of connected mode DRX (C-DRX) and Wake-Up Signal (WUS). Both PEI and WUS can be received by UEs as DCIs over the PDCCH.

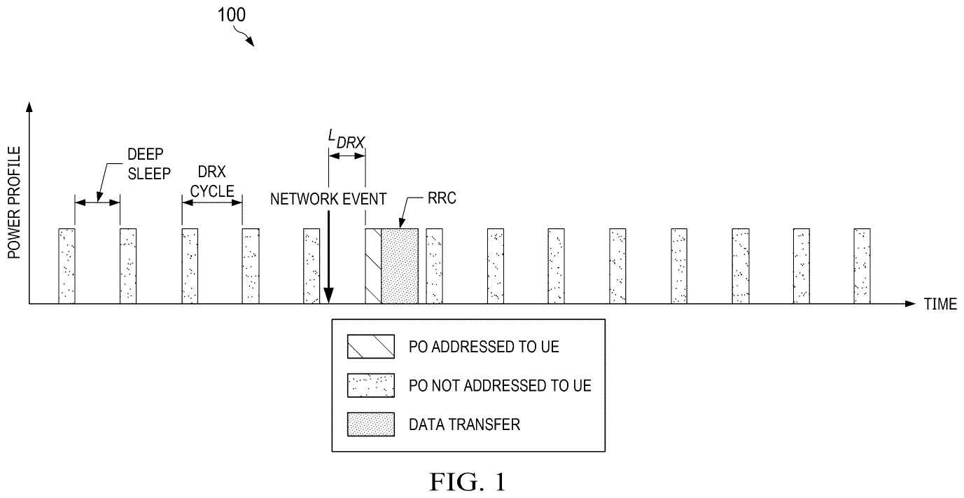

For a UE using DRX in RRC_IDLE or RRC_INACTIVE states, it monitors one PEI occasion (PEI-O) and/or one PO per DRX cycle as shown in FIG. 1, based on PEI configuration, where a PEI-O/PO consists of a set of PDCCH monitoring occasions (MOs) and can consist of multiple time slots. The UE initiates RRC Connection Establishment or RRC Connection Resume procedures upon reception of a core network (CN) initiated or RAN initiated paging, respectively. If PEI is configured, the UE monitors an associated PO in a DRX cycle only if the PEI is detected and the UE's corresponding subgroup is indicated in the PEI.

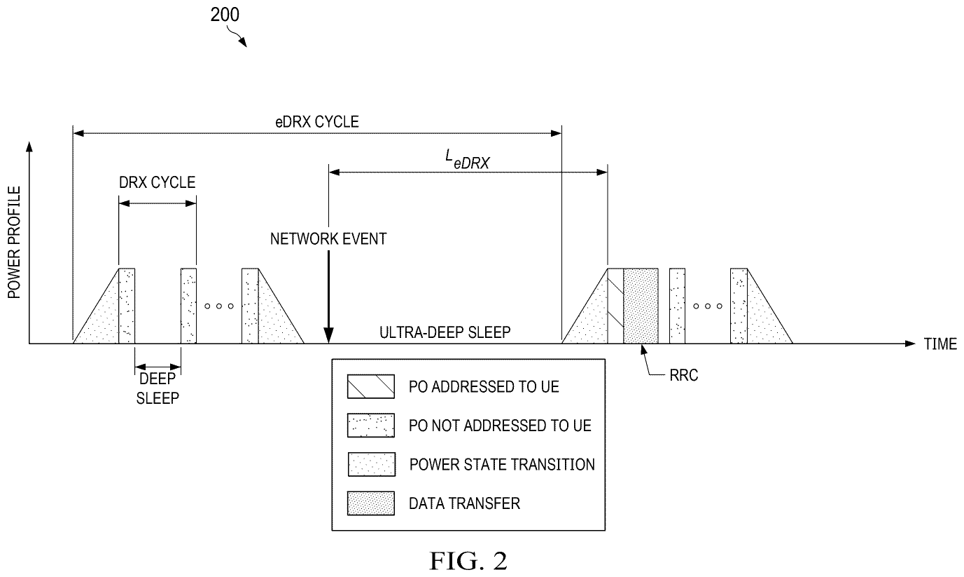

FIG. 1 shows an example protocol flow/timeline 100 based on DRX Configuration in accordance with an embodiment. FIG. 2 is an example protocol flow/timeline 200 based on eDRX (T_{eDRX}>1024 frame) configuration in accordance with an embodiment. The DRX, eDRX, and C-DRX can provide more power saving gain by increasing the duty cycle duration at the expense of higher latency to be expected by the UE. For a UE using eDRX in RRC_IDLE or RRC_INACTIVE states, it monitors one PEI-O and/or one PO per eDRX cycle, based on PEI configuration, as shown in FIG. 1 if the configured eDRX cycle is no longer than 1024 radio frames, where the DRX cycle in FIG. 1 becomes an eDRX cycle. Otherwise, the UE monitors one PEI-O and/or one PO per eDRX cycle, based on PEI configuration, according to a configured DRX cycle during a UE-specific and periodic Paging Time Window (PTW), where the PTW period is determined by the eDRX cycle and the length is configured by upper layers, as shown in FIG. 2. The UE initiates RRC Connection Establishment or RRC Connection Resume procedures upon reception of a CN initiated or RAN initiated paging, respectively. If PEI is configured, the UE monitors an associated PO in a DRX/eDRX cycle only if the PEI is detected and the UE's corresponding subgroup is indicated in the PEI.

PEI and WUS can provide more power saving gain without an impact on latency, but the gain is limited by the power consumption required to decode a DCI over PDCCH. A new WUS that can be received with significantly lower power consumption than existing PEI/WUS designs may enable new trade-off regions of Latency versus Power but will require a dedicated Low-Power Wake-Up Radio/Receiver (LP-WUR) with a simple architecture as discussed next.

### 2.1.2 Power Saving Using LP-WUR

The idea behind power saving using the LP-WUR is to let the main radio (MR), which can consume significant amount of power in range of milliwatts (mWs), stay in a sleep power state for as long as possible and have the LP-WUR, which should consume 2-3 orders of magnitude less power than the MR, monitor for a LP-WUS that acts as a trigger for the MR to wake-up. In various embodiments, an LP-WUS may be a DCI, a paging message, a PDCCH, or any other signal by which a network device notifies a wireless device to wake up its main radio and prepare to receive data from the network device. There are two options for how the LP-WUR may monitor a LP-WUS and the following terminology can be used interchangeably to identify each option.
Option 1: “Continuous” and “Always-on” monitoring
Option 2: “Discontinuous”, “Periodic”, and “Duty-Cycled” monitoring

Further, there may be three different options for the behavior of a UE in response to the reception of a LP-WUS depending on the content of the LP-WUS and network configuration. The three UE behavior options, which may be applicable to both LP-WUS monitoring “Option 1” and “Option 2”, are:
UE_Behavior (1): LP-WUS carries a UE ID and MR is not required to monitor the POs.
UE_Behavior (2): LP-WUS carries a UE ID and/or a UE group ID, and MR is required to monitor legacy POs/PFs.
UE_Behavior (3): LP-WUS carries a UE ID and/or a UE group ID, and MR is required to monitor newly defined POs/PFs.

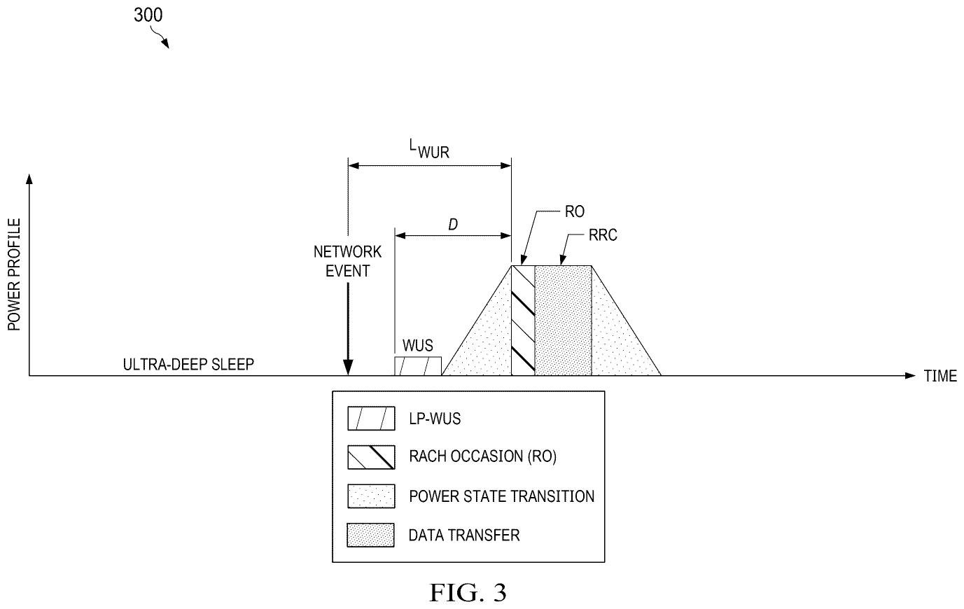

FIG. 3 shows an example protocol flow/timeline 300 based on LP-WUS Configuration with UE Addressing in accordance with an embodiment. UE_Behavior (1), as shown in FIG. 3, may result in the best experienced latency under LP-WUS power saving scheme, especially when continuous monitoring mode (Option 1) is used. This is due to the fact that the UE/LP-WUR may wake-up the main radio to directly initiate RRC Connection Establishment or RRC Connection Resume procedures upon reception of a CN initiated or RAN initiated paging, respectively, as indicated by the LP-WUS. This UE behavior also eliminates the need to align the LP-WUR and MR duty cycles when periodic LP-WUS monitoring is considered. However, this comes at the cost of a large LP-WUS payload size and subsequently a potentially high resource overhead requirement.

Note that the LP-WUR may send the wake-up indication directly to the MR. Alternatively, the UE may comprise a central low power processor/controller acting as an interface between LP-WUR and MR which may then receive the wake-up indication from the LP-WUR and forwards it to the MR. Further, the central controller may receive LP-WUR configuration from the MR and apply it to the LP-WUR.

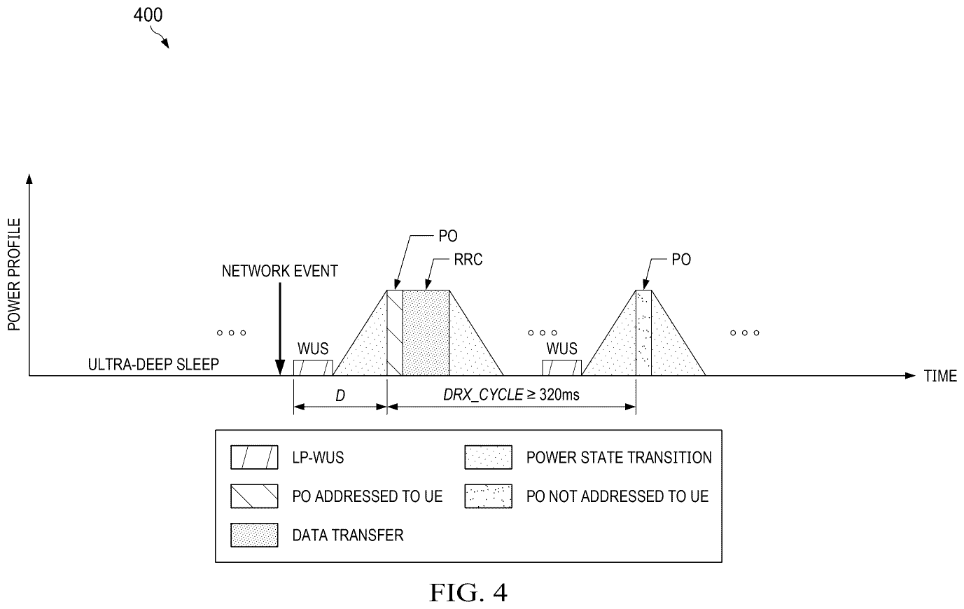

FIG. 4 is an example protocol flow/timeline 400 based on LP-WUS configuration with UE Group Addressing. UE_Behavior (2), as shown in FIG. 4, will result in a LP-WUS latency performance that is limited by the legacy DRX cycle, i.e., {0.32,0.64,1.28,2.56} seconds, and will always underperform the DRX power saving scheme, with the same DRX cycle configuration, in terms of latency. This is due to the fact that the UE will still have to monitor POs using the MR upon wake up in response to the detection of a LP-WUS. However, power saving gain is still expected compared to DRX, i.e., depending on the UE group size, and managed LP-WUS resource overhead is possible due to the potential of using UE group IDs instead of UE unique IDs. Compared to UE_Behavior (1) and based on the UE group size, i.e., when UE group IDs are considered for UE_Behavior (2), there may be a power consumption penalty that may limit any power saving gain considering the MR's expected high transition energy from ‘Ultra-deep sleep’ power state. Further, considering ‘always-on’ monitoring of the LP-WUS under UE_Behavior (2) when the LP-WUS is carrying UE group ID(s) may not result in any latency reduction benefit compared to DRX power saving scheme since the MR will still have to monitor POs according to any of the legacy DRX cycles. However, ‘always-on’ monitoring mode may alleviate the need for the LP-WUR to periodically synchronize with the transmitting entities.

UE_Behavior (3) may correspond to the definition of shorter RRC IDLE/INACTIVE state DRX cycles, i.e., <320 ms, which may result in a better LP-WUS latency performance compared to UE_Behavior (2) without any impact on power consumption due to the use of LP-WUR and at a managed LP-WUS resource overhead due to the use of UE group IDs.

Both UE_Behavior (2) and (3) may also apply for the case when the LP-WUS carries a unique UE ID but the MR is still required to monitor POs. However, for a LP-WUS with a considerably low false alarm rate (FAR), it might be unreasonable to mandate MR monitoring of POs after detection of LP-WUS carrying a unique UE ID. That is because PO monitoring by the MR will add to the power consumption without providing any additional information to the UE.

### 2.2Low-Power Receiver Architectures

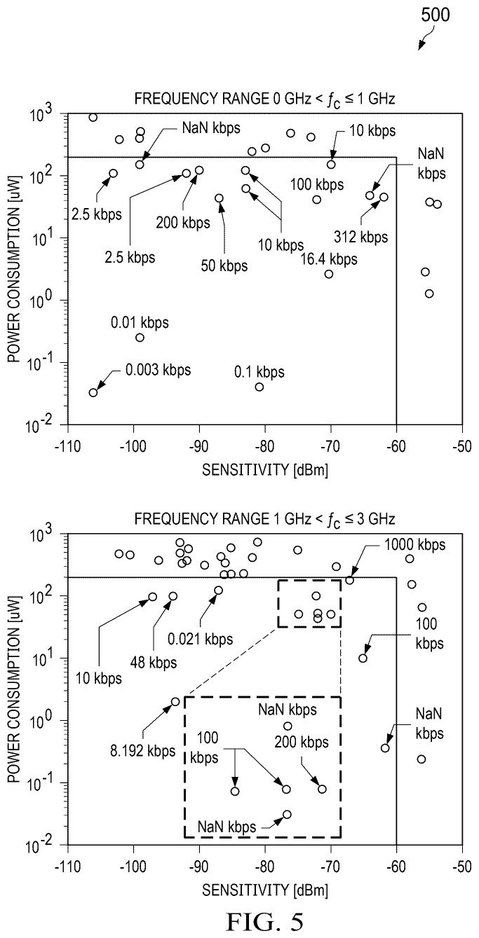

FIG. 5 shows a survey 500 of low-power receiver architectures in accordance with an embodiment. Aa dedicated low-power receiver, LP-WUR, has been proposed as a supplement to a MR of a UE to alleviate the power consumption associated with the current need of UEs to periodically wake up once per DRX cycle to monitor PDCCH. FIG. 5 shows the trade-offs between receiver power consumption, sensitivity, and supported data rate for two carrier frequency ranges, f_{c}≤1 GHz and 1 GHZ<f_{c}≤3 GHZ. FIG. 5 suggests that receiver architectures consuming power of 40 μW<P_{c}≤140 μW can support sensitivity levels −97 dBm<Pₘᵢₙ≤−70 dBm at data rates 10 kbps≤R<200 kbps using non-coherent OOK modulation. In the following sections, a few of those receiver architectures are examined. In general, examined low-power receiver architectures in Section 2.2.1 can be categorized as mixer-first architectures, such as the uncertain-IF, the sub-sampling, and the dual uncertain-IF architectures; and envelope detection first architectures, such as the double-sampling and the 2-tone reception architectures. In Section 2.2.2, few low-power receiver architectures that are suitable for FSK modulation are presented.

### 2.2.1 ASK Receiver Architectures

In this section, Amplitude Shift Keying (ASK), e.g., OOK, receiver architectures are discussed in the context of the types identified in 3GPP RAN1 discussions, i.e., RF envelope detection and IF/BB envelope detection architectures.

### 2.2.1.1 RF Envelope Detection

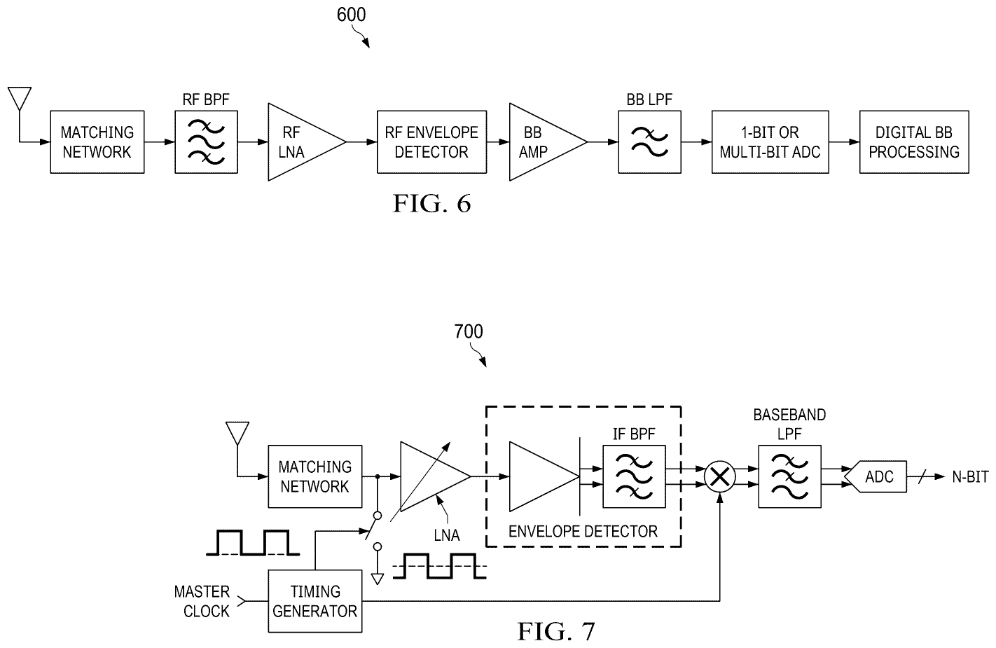

FIG. 6 shows a basic block diagram for RF envelope detection receiver architecture 600 in accordance with an embodiment. A basic block diagram for RF envelope detection is described in RAN1 #110bis-e and is shown in FIG. 6. The RF signal is converted directly into baseband using the RF envelope detector, eliminating the need for LOs or Phase-Locked Loops (PLLs). Signal digitization for digital baseband processing can be performed using a 1-bit or multi-bit ADC. The RF Low Noise Amplifier (LNA) and/or BB Amplifier (AMP) can be optionally considered. For this architecture, high-Q matching networks and/or RF bandpass filter (BPF) are considered to suppress adjacent channel interference or interference from legacy NR signal and/or other LP-WUS on adjacent subcarriers.

FIG. 7 shows an example of synchronized switching/double-sampling receiver architecture 700 in accordance with an embodiment. The, originally termed, double-sampling architecture is another architecture that attempts to reduce the power consumption overhead associated with the front-end (FE) PLLs through the utilization of low-frequency oscillators that are 1 to 2 orders of magnitude below target RF frequency. The architecture also mitigates the impact of the 1/f (flicker) noise through the combination of the chopping/switching stage at RF, double-sampling/switching stage at IF, and utilization of a clock frequency above the flicker noise corner frequency. An example double-sampling architecture is shown in FIG. 7 where the IF BPF stage may be followed by an amplification stage. Since RF envelope detection is utilized in this architecture, receiver selectivity is mainly controlled by the RF FE filters.

FE selectivity is sometimes compromised, i.e., a −3 dB bandwidth of 21 MHz/59 MHz in the 915 MHz/2.4 GHz band, for the low power consumption of ˜51 μW and the receiver architecture achieves a sensitivity of −75 dBm/−80 dBm using a data rate of 100 kbps/10 kbps in the 915 MHz band. In [10], the receiver architecture provides a FE-3 dB bandwidth of 110 MHZ, that is determined by the LNA and the input matching network, and achieves a sensitivity of −86.5 dBm/−61 dBm using a data rate of 10 kbps for a power consumption of 146 μW/64 μW in the 780-950 MHz bands (a data rate of 100 kbps is supported at ˜5 dB degradation in sensitivity). However, the receiver selectivity may be improved to a −3 dB bandwidth of only 13 MHz using a high-Q RF SAW filter at the expense of a ˜2 dB degradation in sensitivity. Further power consumption reduction for the receiver architecture may be achieved by discarding LNAs at RF at the expense of further degradation in receiver sensitivity.

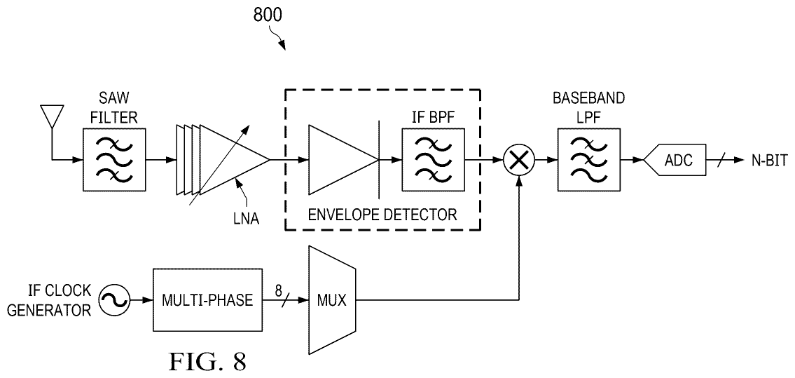

FIG. 8 shows an example of a 2-tone reception envelope detection receiver architecture 800 in accordance with an embodiment. Like the double-sampling architecture, the architecture shown in FIG. 8 utilizes RF envelope detection and low-frequency oscillators for power consumption reduction. However, instead of the utilized switching/chopping technique in the double-sampling architecture, i.e., multiplying the received RF signal with a square wave of low frequency, some architectures use a 2-tone transmission scheme. Further, the architecture treats the double-sampling/switching stage at IF, i.e., after envelope detection, as a mixing stage and utilizes a FE SAW filter to improve the receiver's interference rejection capability.

The specific signal design where a 2-tone transmission scheme is considered allows the use of BPSK-IF as a modulation scheme for a non-coherent envelope detection-based receiver architecture. It also improves the receiver selectivity for better in-band interference rejection. In some architectures out-of-band interference rejection is managed through the SAW filter and in-band interference rejection through signal design and IF BPF after envelope detection. It achieves a sensitivity of −83 dBm/−56 dBm using a data rate of 10 kbps for a power consumption of ˜121 μW/63.5 μW (+10 μW for IF clock generation) in the 915 MHz band. The sensitivity of this architecture is similar to a double-sampling architecture when accounting for the losses due to the SAW filter. However, it provides a much better interference rejection than the double-sampling architecture as it can tolerate between-19 dB to −10.5 dB of in-band carrier-to-interference ratio (CIR) at +1 MHz offset from each tone based on power consumption.

### 2.2.1.2 IF/Baseband Envelope Detection

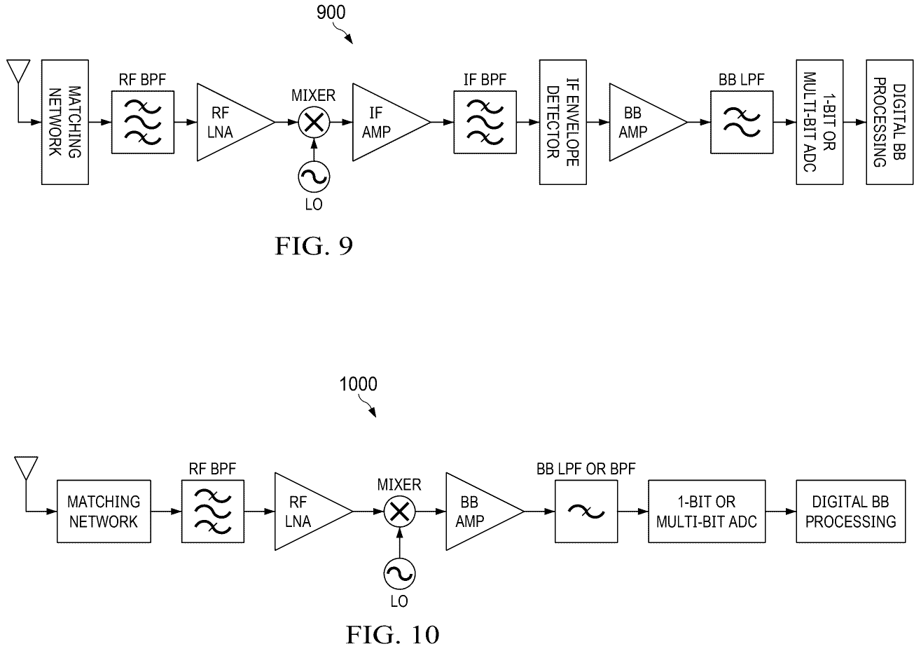

FIG. 9 shows a basic block diagram for IF envelope detection receiver architecture 900 in accordance with an embodiment. FIG. 10 shows a basic block diagram for BB envelope detection receiver architecture 1000 in accordance with an embodiment. Basic block diagrams for IF and BB envelope detection are described in RAN1 #110bis-e and are shown in FIG. 9 and FIG. 10, respectively. In IF envelope detection (FIG. 9), the RF signal is first converted to an IF signal using an LO and an RF mixer, and then the IF signal is converted to a BB signal using the IF envelope detector. In this architecture, low power consumption is achieved by relaxing the accuracy and stability requirements of the LO. Signal digitization for digital baseband processing can be performed using a 1-bit or multi-bit ADC. The RF Low Noise Amplifier (LNA) and/or IF AMP and/or BB AMP can be optionally considered. For this architecture, high-Q matching networks and/or RF BPF and/or IF BPF are considered to suppress adjacent channel interference or interference from legacy NR signal and/or other LP-WUS on adjacent subcarriers. Further, an image rejection filter or an image rejection mixer is required. On the other hand, the RF signal in the BB envelope detection architecture (FIG. 10) is directly converted to BB signal using an LO and an RF mixer. A high-Q matching networks and/or an RF BPF and/or a BB BPF/LPF are considered to suppress adjacent channel interference or interference from legacy NR signal and/or other LP-WUS on adjacent subcarriers. Further, an image rejection filter is not required.

Like the double-sampling architecture, the sub-sampling architecture attempts to reduce the power consumption overhead associated with the FE PLLs through the utilization of low-frequency oscillators that are 1 to 2 orders of magnitude below target RF frequency. However, instead of the utilized switching/chopping technique in the double-sampling architecture, i.e., multiplying the received RF signal with a square wave of low frequency, the sub-sampling architecture in uses the low frequency clock to sub-sample the received RF signal and generate a signal at IF. Further, some receiver architectures utilize the uncertain IF topology, i.e., utilizes a low-power and low-accuracy reference clock, but improves receiver selectivity through the utilization of a period-based calibration circuit.

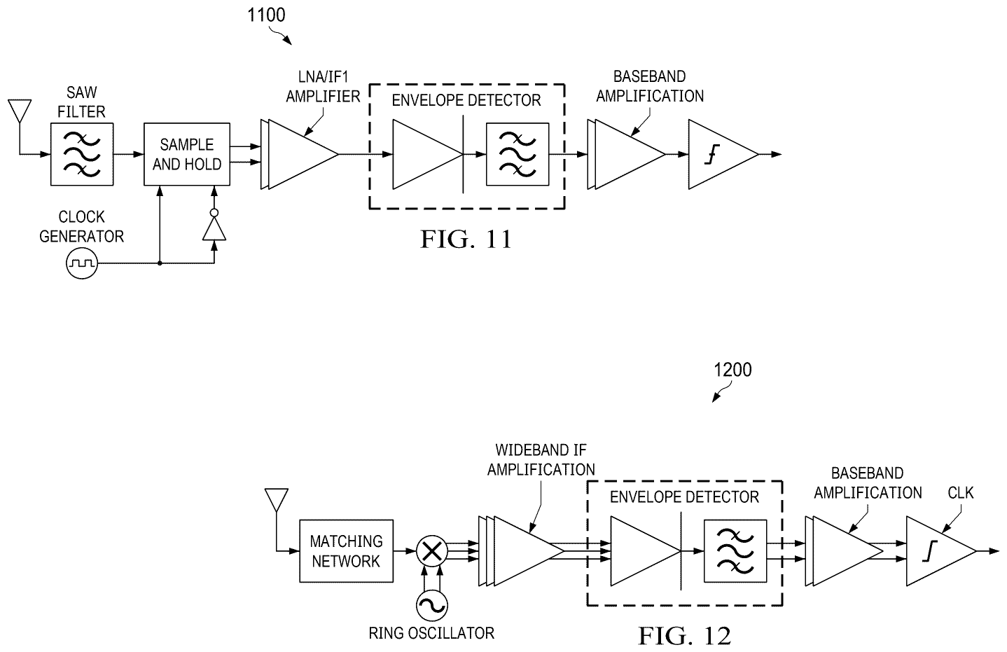

FIG. 11 shows an example of sub-sampling receiver architecture 1100 in accordance with an embodiment. An example sub-sampling architecture is shown in FIG. 11 where the receiver selectivity is determined by a SAW filter and a two active-inductor based amplifier stages providing ˜13 MHz of bandwidth. The architecture shown in FIG. 11 achieves a sensitivity of −75 dBm using a Manchester encoded data rate of 200 kbps for a power consumption of ˜22.9 μW (calibration circuit may on average consume 0.3 μW for 1 ms per 100 ms calibration) in the 915 MHz band.

FIG. 12 shows an example of uncertain IF receiver architecture 1200 in accordance with an embodiment. The uncertain IF architecture is one of the architectures that attempts to reduce or eliminate the power consumption overhead associated with the front-end (FE) Phase Locked Loops (PLLs) and Low Noise Amplifiers (LNAs). This is achieved through the utilization of (1) a low-power and low-accuracy unlocked local oscillators (LOs) such as the ring oscillators, and (2) LNAs at IF instead of RF. The power consumption overhead associated with LNAs can further be eliminated by entirely discarding LNAs from the architecture at the expense of receiver sensitivity. An example uncertain IF architecture is shown in FIG. 12 where receiver selectivity, i.e., blockers elimination, is achieved through the utilization of passive high-Q front-end filters with additional filtering after the mixer, which is easier provided at lower frequencies. The architecture in FIG. 12 provides a −3 dB bandwidth of 54 MHz through RF filtering while the IF bandwidth is limited by the utilized ring oscillator uncertainty.

Therefore, in this architecture, sensitivity is limited, in general, by the integrated noise presented by the wide IF bandwidth required to deal with the LO uncertainty. In an architecture such as shown in FIG. 12, a sensitivity of −88 dBm for 10⁻³ BER may be achieved using a Manchester encoded (information bits are encoded as transitions from low-to-high or high-to-low signal levels) data rate of 250 kbps at a power consumption of ˜50 μW in the 2.45 GHz band.

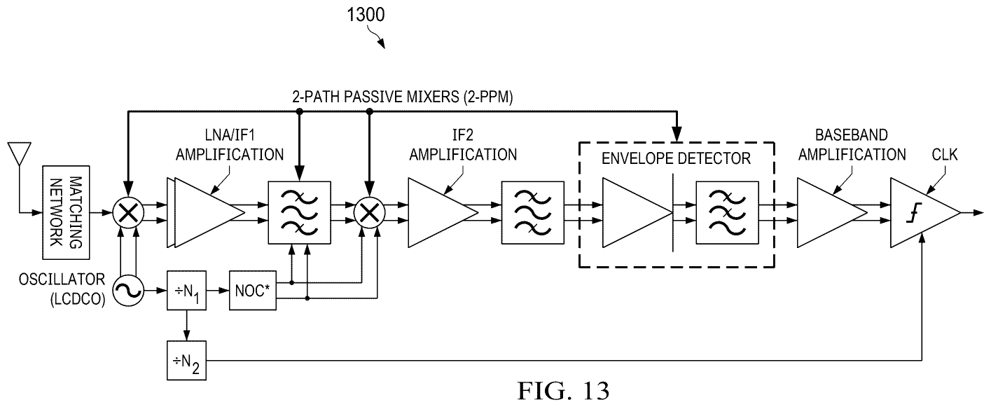

FIG. 13 shows a representation of the dual uncertain-IF receiver architecture 1300 in accordance with an embodiment. The dual uncertain-IF receiver architecture in in FIG. 13, reuses the uncertain-IF receiver architecture to reduce power consumption while improving the receiver's selectivity by combining an unlocked low-Q resonator-referred LO (LC-DCO), where LC-DCO provides more accuracy than ring oscillators at the cost of a slight increase in power consumption, and distributed multi-stage high-Q N-path passive mixer (N-PPM) filtering technique.

The dual uncertain-IF architecture selectivity is then provided by two main narrow band-pass filtering stages, one at each of the two IF frequencies, enabling a tolerance of in-band carrier-to-interference ratio (CIR) between −25 dB to −22 dB at +3 MHz offset. The FE matching network and RF passive mixer provide an effective bandwidth of 20 MHz while the first IF passive mixer provides an effective bandwidth of 1 MHz. The architecture achieves a sensitivity of −97 dBm/−92 dBm using a data rate of 10 kbps/50 kbps for a power consumption of ˜99 μW in the 2.4 GHz band.

Envelope detection in the dual uncertain-IF architecture utilizes the high linearity response of the N-PPM to perform direct down-conversion of the signal from the second IF frequency to DC, ensuring bandwidth reduction and removal of the LO uncertainty effects.

### 2.2.2 FSK Receiver Architectures

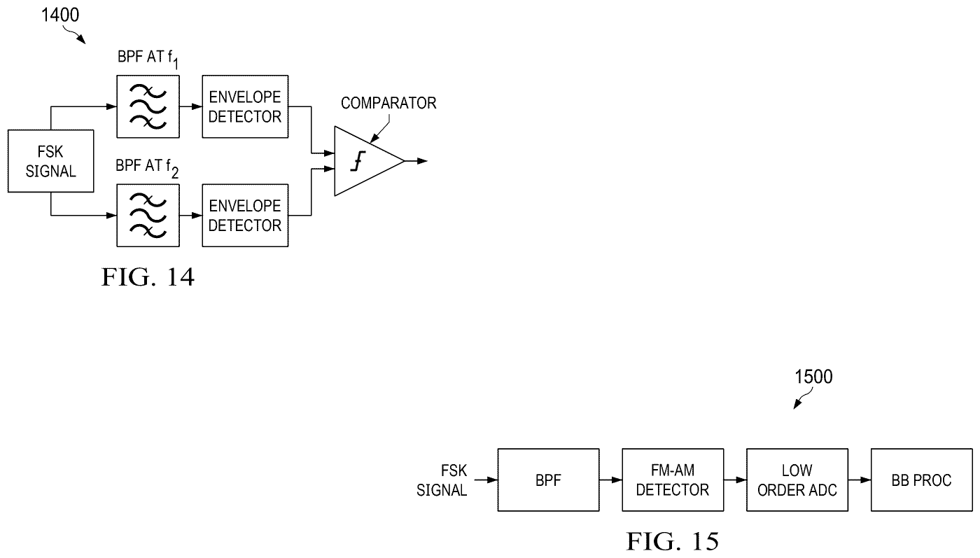

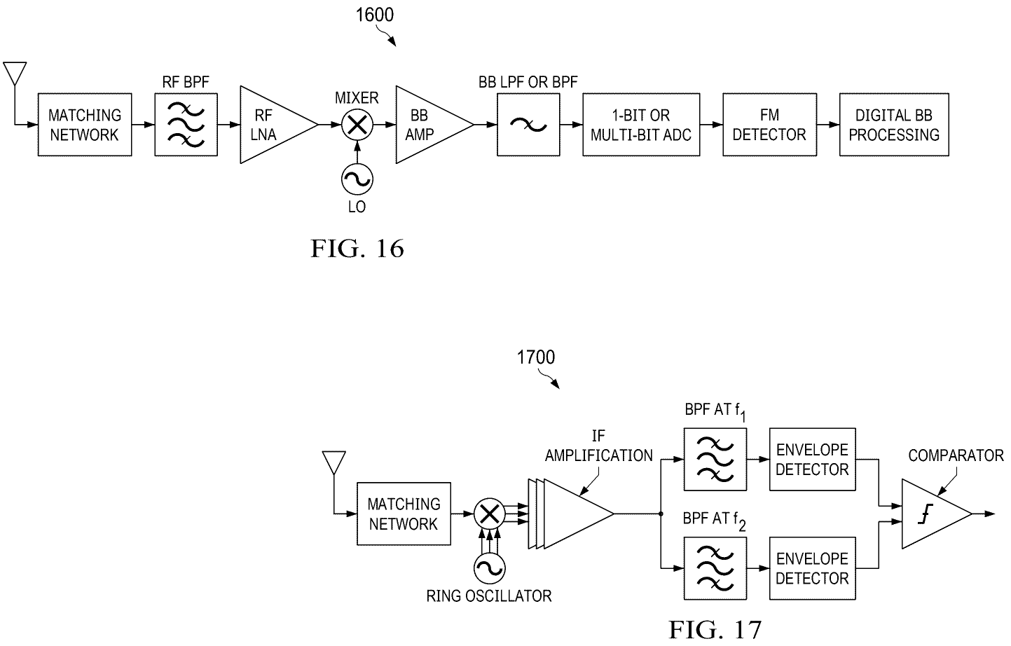

Low power receiver architectures that can support FSK modulation are also being discussed in 3GPP RAN1 as part of the LP-WUS study item. Two example architectures have been considered so far, the first example (parallel OOK receivers) reuses the OOK receiver architectures discussed in Section 2.2.1 whereas the second example utilizes an FM-to-AM detector. An example architecture for a 1-bit FSK (2-FSK) receiver is shown in FIG. 14 based on the parallel OOK receivers example where each of the envelope detectors can be implemented using any of the OOK receiver architectures discussed in Section 2.2.1. On the other hand, two alternative implementations are possible for FM-to-AM detector based FSK receivers. In one implementation, the FM-to-AM detector is implemented in the analog domain, as shown in the example in FIG. 15, whereas the FM-to-AM detector is implemented in the digital domain for the second implementation, as shown in the example in FIG. 16.

For the example architecture shown in FIG. 14, a signal transmitted using frequency resource f₁ may be used to indicate a transmitted bit 0, and a signal transmitted using frequency resource f₂ may be used to indicate a transmitted bit 1. The received FSK signal is then passed into two bandpass filters centered at f₁ and f₂, respectively, into the envelope detector circuits. The output from the envelope detectors is then fed into a comparator to decide on whether a bit 0 or bit 1 is transmitted.

Note that the FSK receiver, as shown in FIG. 14, may be based on RF envelope detector receiver architectures. Therefore, the two bandpass filters may be RF filters which can be costly and/or bulky make the architecture unattractive for implementation. Alternatively, an IF envelope detection-based receiver architectures may be utilized to avoid the costly and/or bulky implementations. An example 1-bit FSK (2-FSK) receiver using the IF envelope detection-based receiver architecture is shown in FIG. 17. As mentioned in Section 2.2.1, in order to reduce power consumption of IF envelope detection architecture, a low accuracy and stability LO, e.g., a ring oscillator, may be used. The LO's low accuracy, e.g., +200 ppm, can result in a frequency offset of +400 kHz at a carrier frequency of 2 GHz. Such a frequency offset may require guard bands of comparable bandwidths to avoid/mitigate interference which may subsequently result in an increase in the required frequency resources for such an architecture.

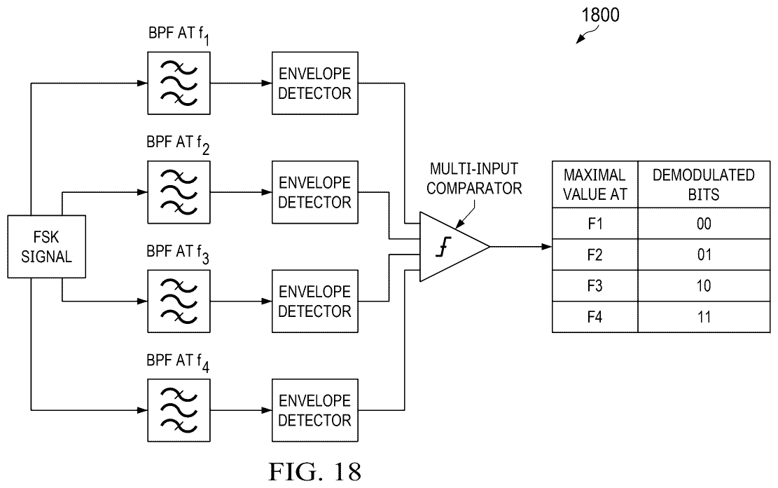

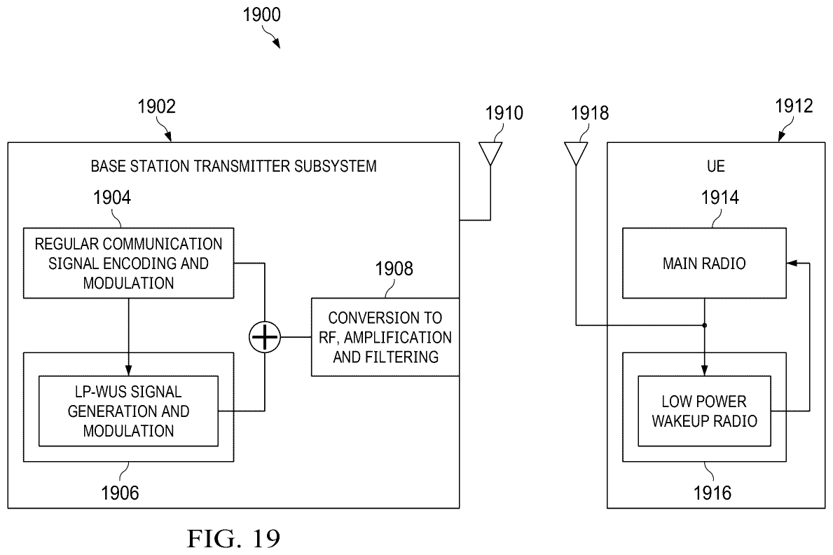

In order to increase the data rate received by an FSK receiver, a higher modulation order may be considered, i.e., M-FSK (M≥4). An example 2-bit FSK receiver, i.e., 4-FSK, is shown in FIG. 18, where 4 different frequency resources are used to indicate 2 bits as exemplified in the table of FIG. 18. At the FSK receiver, 4 bandpass filters centered at the 4 frequencies on 4 different branches are used prior to envelope detection. The output of the envelope detectors is then fed into a decision-making unit which decides on one of the 4 different 2-bit combinations based on the relative strength/amplitude of the envelope detectors output.

### Section 3

In RAN1 #110bis-e, three types of receiver architectures were agreed to be considered for the LP-WUR as suitable for OOK modulation. Those are architectures with RF envelope detection, heterodyne architecture with IF envelope detection, and homodyne/zero-IF architecture with baseband envelope detection. Those architectures can also be applicable for other modulation schemes such as FSK.

The RF envelope detection architecture achieves low-power consumption by avoiding the utilization of Local Oscillators (LOs) and Phase-Locked Loops (PLLs) whereas the IF/Baseband envelope detection architectures achieve low-power consumption by relaxing the accuracy and stability requirements of the LO. The low power consumption of those architectures can allow them to operate in ‘continuous’ and/or short ‘duty-cycled’ monitoring modes without significant impact on overall UE power consumption. However, such new modes of signal monitoring can result in an increase in false alarms (wake-ups) to be experienced by the LP-WURs, which may lead to higher power consumption, even for relatively low false alarm rates. Further, the increase in false alarms can lead to unnecessary LP-WUS miss-detections due to interaction between main radio and LP-WUR and the expected long transition time for the main radio from “ultra-deep sleep”/“deep sleep” power states to an active power state in the RRC IDLE/INACTIVE states or the relatively long transition time from “deep sleep”/“light sleep” to an active power state in the RRC CONNECTED state. Therefore, a solution that can mitigate the impact of false alarms on LP-WURs' power consumption and triggered miss-detections with proper activation and deactivation of LP-WUS monitoring is desired.

### Section 4

The aim of this section is to introduce schemes for interaction between LP-WUR, main radio, and network to mitigate the impacts of LP-WURs' false alarms on main radio's power consumption, UE's experienced latency due to false alarm triggered miss-detections, and network resource utilization due to repeated LP-WUS transmissions resulting from false alarm triggered miss-detections. The impacts are discussed again in details in Section 4.1, the embodiment schemes are presented in Section 4.2, and procedures that enable the embodiment schemes are discussed in Section 4.3.

FIG. 19 shows a wireless system 1900 for low power wakeup signaling in accordance with an embodiment. System 1900 is an example of a system that may be utilized to implement the disclosed methods. System 1900 includes a base station transmitter subsystem 1902 and a UE 1912. The base station transmitter subsystem 1902 includes a regular communication signal encoding and modulation unit 1904, a LP-WUS signal generation and modulation unit 1906, a conversion to RF amplification and filtering unit 1908, and an antenna 1910 for transmitting and receiving signals. UE 1912 includes a main radio 1914, a low power wakeup radio 1916, and an antenna 1918 for transmitting and receiving signals. Low power wakeup radio 1916 is used to support sleep mode operation of UE 1912. This may be particularly useful for Internet of Things (IoT) devices. When the UE 1912 is in sleep mode, the main radio 1914 is shut down to reduce power consumption. The low power wakeup radio 1916 monitors the over-the-air signal for LP-WUS from the base station transmitter subsystem 1902. Once the low power wakeup radio 1916 detects the LP-WUS, it sends a control signal to wake up the main radio 1914 for communication. The base station transmitter subsystem 1902 generates the LP-WUS by the LP-WUS signal generation and modulation unit 1906 and then transmits the LP-WUS, in addition to a regular communication signal generated by the regular communication signal encoding and modulation unit 1904, to the UE 1912 to wake up the UE 1912 that is in sleep mode so that the UE 1912 can communicate with the base station transmitter subsystem 1902. It should be noted that, in various embodiments, for various reasons, the network device may transmit more than one LP-WUS and the UE 1912 may receive more than one valid LP-WUS.

4.1 False Alarms and their Impact on LP-WURs

For proper understanding of the impact of false alarms and False Alarm Rate (FAR) on LP-WURs, identification of the potential sources of false alarms is required. In general, there can be two sources of potential false alarms (false wake-up indications) to the LP-WUR, which can be classified into:
1) Grouping: under this category/class, the LP-WUR of a UE is falsely alarmed for wake-up due to the correct detection of a LP-WUS which is intended to wake-up/alarm the LP-WUR of another UE within the same UE group.
2) Noise/Interference: under this category/class, the LP-WUR of a UE is falsely alarmed for wake-up due to the false detection of a LP-WUS due to presence of noise and/or interference where interference may be another LP-WUS intended for other UEs/UE groups or any other signal.

Proper design of the LP-WUS can result in a much lower contribution to false alarms from the second source (Noise/Interference) than the first source (Grouping). Further, it can be noted that the first source (Grouping) may not have a significant impact on the latency experienced by a UE but will have an impact on the UE's power consumption and expected power saving gain due to the employment of LP-WUR.

The impact of the first source of false alarms on power saving gain can be understood/captured as an increase in the arrival rate of a considered traffic model. On the other hand, the second source (Noise/Interference) of false alarms may have an impact on both UE's experienced latency and power saving gain depending on the UE's configuration for LP-WUS monitoring and response to LP-WUS detection, i.e., either true detection or false detection. Additionally, similar to impact of Miss-Detection Rate (MDR), the second source of false alarms may result in additional resource overhead associated with the need for LP-WUS re-transmissions.

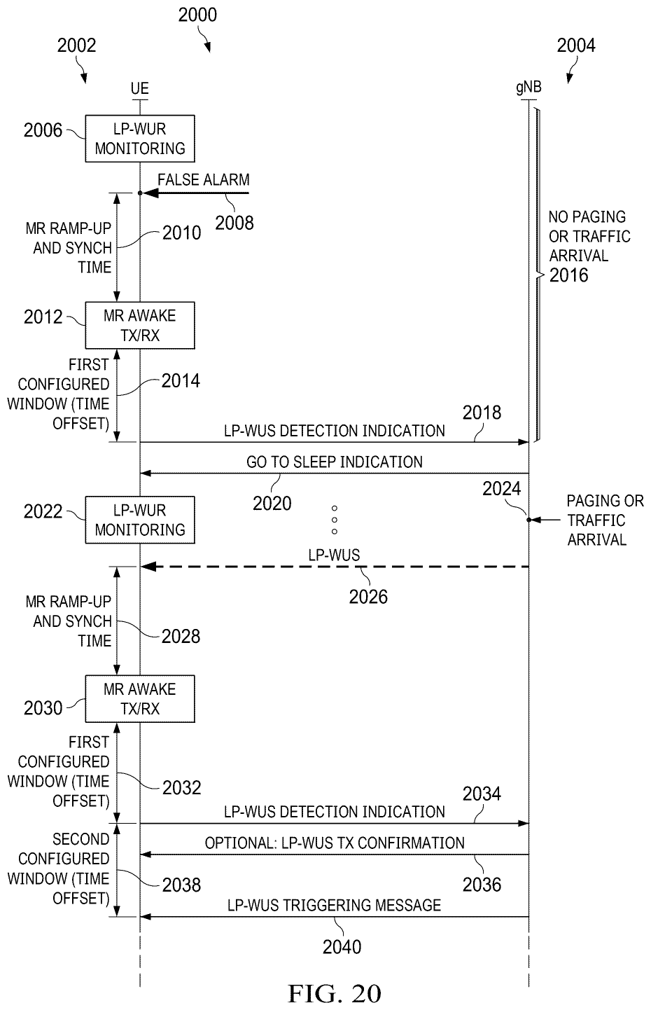

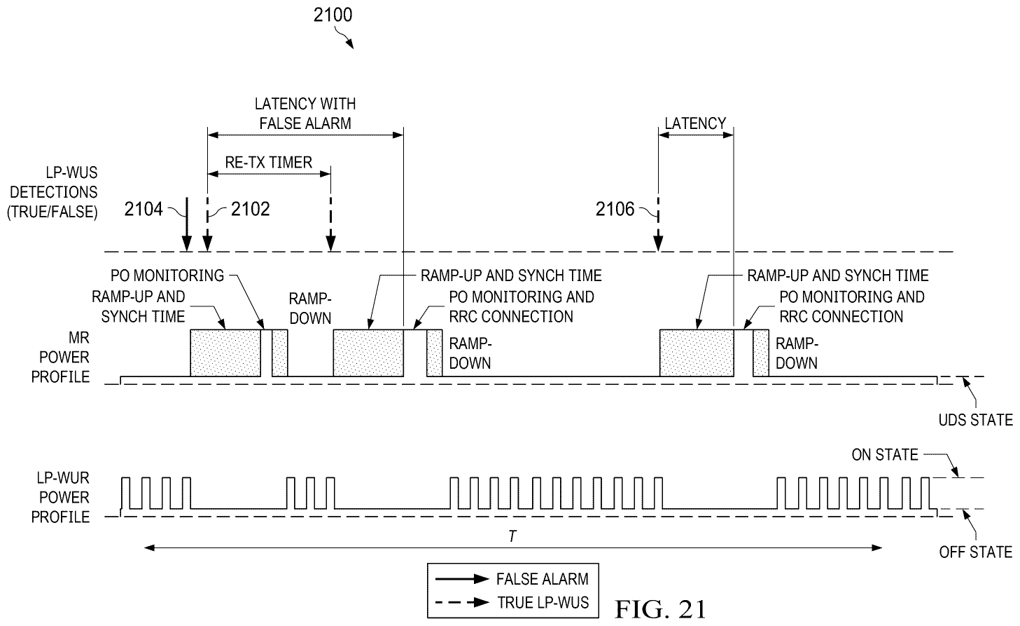

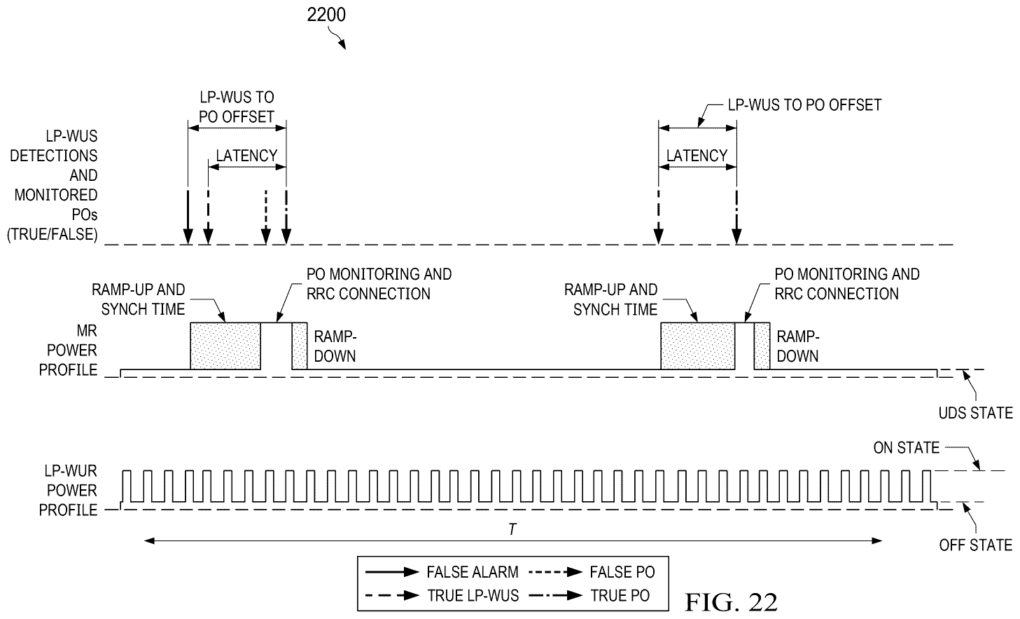

FIG. 20 is a message flow diagram of a method 2000 for waking up a sleeping UE using a LP WUS in accordance with an example embodiment. Method 2000 shows an example of a UE 2002 and a gNB 2004 exchanging messages. The UE 2002 is configured with a set of timers and/or signaling exchange to trade-off network resource overhead and UE power consumption by allowing the main radio to signal a detection indication to the NW upon LP-WUS detection. The network can signal: 1) a “go to sleep” indication to the UE if LP-WUS detection was due to a false alarm; or 2) “TX confirmation” and/or “LP-WUS triggering message” if the LP-WUS detection is true or paging is available for the UE/UE-group. An LP-WUS triggering message is any signal received from the network device that indicates that the wireless device should wake up its main radio in preparation to receive date from the network device. This method therefor also avoids any latency that might result from false alarm triggered miss-detections and can reduce resource overhead (LP-WUS resources>MR indication resources). A false alarm is any signal or other phenomena that is not an actual LP-WUS or LP-WUS triggering message sent by the network device that is received by the LP-WUR that causes the LP-WUR to initiate a wake-up procedure of the main radio

At step 2006, the UE 2002 monitors LP-WUR. At step 2008, the UE 2002 detects a false alarm. After the expiration of MR ramp-up and synch time (step 2010), the main radio Tx/Rx awakes (step 2012). After the expiration of a first configuration window (time offset) (step 2014), the UE 2002 sends a LP-WUS detection indication (step 2018) which the gNB 2004 receives after a period of no paging or traffic arrival (step 2016). The first configuration window (time offset) is the time it takes for the main radio to wake up from a sleep state and be ready to transmit and receive data. The UE sends the LP-WUS detection indication to the network device to indicate to the network device that the wireless device has received the LP-WUS and is ready to receive data.

In an embodiment, the UE 2002 sending an LP-WUS detection indication in step 2018 is contingent upon failure of the UE 2002 receiving an LP-WUS triggering message during the first configured window. In an embodiment, if the UE 2002 receives an LP-WUS triggering message during the first configured window, the UE 2002 does not send a LP-WUS detection indication in step 2018. In some embodiments, the network device does not begin to transmit data to the wireless device until it receives the LP-WUS detection indication from the wireless device indicating that the wireless device is ready to receive data. In other embodiments, the wireless device does not send the LP-WUS detection indication, but rather the network device merely waits for the expiration of the first configuration window, which is equal to the time necessary to awaken the main radio, and then begins transmitting data to the wireless device after expiry of the first configuration window.

The gNB 2004 then sends a go to sleep indication to the UE 2002 (step 2020). If the UE 2002 detects an LP-WUS triggering message that is not a false alarm, but has actually been sent by the gNB 2004, during the first configured window 2014, the gNB 2004 would not send a go to sleep indication 2020 to the UE 2002 because, although the LP-WUS detection indication 2018 that the UE 2002 sent was due to a false alarm, an intervening valid LP-WUS having been sent by the gNB after the false alarm, but before the LP-WUS detection indication 2018 is sent by the UE 2002 means that the main radio should be awake and prepared to receive data from the gNB 2004. The UE 2002 then puts the main radio back to sleep and begins LP-WUR monitoring with the low power radio (step 2022). At step 2024, the gNB receives paging of traffic arrival and then sends the UE 2002 a LP-WUS (step 2026). After the expiration of main radio ramp-up and synchronization time (step 2028), the main radio Tx/Rx awakens (step 2030). After the expiration of a first configured window (time offset) (step 2032), the UE 2002 sends a LP-WUS detection indication message (step 2034) to the gNB 2004. The gNB 2004 then optionally sends a LP-WUS TX confirmation message (step 2036) to the UE 2002. In an embodiment, the UE 2002 sending an LP-WUS detection indication in step 2034 is contingent upon failure of the UE 2002 receiving an LP-WUS triggering message during the first configured window. In an embodiment, if the UE 2002 receives an LP-WUS triggering message during the first configured window, the UE 2002 does not send a LP-WUS detection indication in step 2034. The gNB 2004 then sends an LP-WUS triggering message (step 2040) which is received by the UE 2002 after the expiration of a second configured window (time offset) (step 2038).

FIG. 21 shows a main radio and LP-WUR processing timeline 2100 in the presence of false alarms due to noise/interference in accordance with an embodiment. An example UE behavior is shown in FIG. 21 where the LP-WUR is configured with a duty-cycle shorter than the time required to wake-up the main radio, and the LP-WUR is not required to continue monitoring LP-WUS after sending a wake-up indication to the main radio. This is a typical behavior of a non-access point (non-AP) station (STA) as defined in IEEE802.11ba. Note that the LP-WUR may still continue monitoring for LP-WUS where an interrupt register may be used to monitor for interrupt sources, but the main radio may not poll the LP-WUR if it had received a LP-WUS while it was waking up. The figure shows that for this example, the UE will miss the detection of a true LP-WUS2102 due to the (Noise/Interference) false alarm 2104, leading to potential increase in latency, UE power consumption, and resource overhead. The increase in latency is further clarified by comparing to the second case in FIG. 21, where the UE directly wakes-up due to a true LP-WUS detection 2106. Note that the issue of false alarm triggered miss-detection is magnified, i.e., the probability of the event happening, by the expected long duration of ramp-up and synchronization time required by the main radio to transition from “ultra-deep sleep” (UDS) power state, e.g., for a UE in RRC IDLE or RRC INACTIVE state, to an active power state. Additionally, the ‘continuous’ and short ‘duty-cycled’ monitoring modes/options can result in an increase in the number of false alarms experienced by the LP-WUR, even for a relatively low FAR, which can further increase the probability of false alarm triggered miss-detections. Note that this behavior may also apply for a UE in the RRC CONNECTED state utilizing the LP-WUR to monitor for LP-WUS which can be used to trigger PDCCH monitoring based on a UE specific search space (USS) or a configured connected mode DRX cycle (C-DRX).

### 4.2False Alarm Handling Schemes

In this section, three different LP-WUR's false alarms handling schemes are described, a “Dual LP-WUR and MR operation” is described in Section 4.2.1, a “Repetitive LP-WUS Transmission” is described in Section 4.2.2, and a “Limited LP-WUR Duty-Cycle” is described in Section 4.2.3. It is also possible to consider variants or combinations of the embodiment schemes to enable trade-off between UE's experienced latency, power saving gain, and network resource overhead.

### 4.2.1 Dual LP-WUR and MR Operation

FIG. 22 shows a dual LP-WUR and Main Radio Operation timeline 2200 in the presence of noise/interference false alarms in accordance with an embodiment. The dual LP-WUR and MR operation scheme described herein can mitigate the impact of LP-WUR's false alarms on latency and resource overhead, but at the expense of main radio's power consumption. The scheme is illustrated in FIG. 22 where, as opposed to the typical scheme shown in FIG. 21, the LP-WUR does not stop monitoring for LP-WUS after a LP-WUS detection and signaling of a wake-up indication to the main radio. On the contrary, the LP-WUR continues monitoring for LP-WUS after the first LP-WUS detection, i.e., true or false, and even while the main radio is ramping up and performing synchronization in preparation to transition to an active power state, e.g., to start monitoring for POs or PDCCH monitoring occasions based on UE-specific search space(s). Further, the LP-WUR sends/signals additional wake-up indications to the main radio upon each detection of any additional/subsequent LP-WUSs, i.e., true or false.

The main radio, subsequently, resets a configured timer based on each received wake-up indication, i.e., from the LP-WUR, where the timer value corresponds to an expected time interval/duration between a true LP-WUS detection and a nearest PO, or PDCCH monitoring occasion based on UE-specific search space(s), available for monitoring by the main radio. The value of the timer can be a preconfigured value at the UE, signaled directly by the network in any of NAS signaling, RRC signaling, and system information, or derived by the UE based on other parameters configured/signaled by the network as part of, e.g., paging configuration.

At the end/expiry of the timer, the main radio can determine/confirm the nature of the wake-up indications received since the first initiation of the timer, i.e., true or false, and decide on whether an action, e.g., RRC connection establishment or PDCCH monitoring based on UE-specific search space(s), needs to be taken before returning to a non-active, e.g., “ultra-deep sleep” or other sleep, power state. There can be multiple LP-WUS signals sent to the wireless device. The initial timer is configured based on the first LP-WUS signal, but if another true LP-WUS signal is received after the first one while the main radio is active, it may want to reset the timer to stay on for a longer period of time than it would have if only the first LP-WUS was received. Alternatively, the main radio it may need to perform some other action necessitating it staying active past the expiration of the first timer. Therefore, the embodiment scheme might require the main radio to remain awake for a longer period of time resulting in a potential increase of UE's power consumption, e.g., if all wake-up indications are a result of LP-WUR's false alarms, but shall solve the latency and resource overhead problem associated with false alarm triggered miss-detections as mentioned earlier. It shall be noted that the potential increase in UE's power consumption from this solution may still be less than that expected from the scheme in FIG. 21.

Note that the impact on the potential increase in UE's power consumption can be reduced by limiting the maximum duration a UE may remain in an active power state in response to the detection of LP-WUSs. The savings can be achieved by limiting the overall duration from the first initiation of the timer till the expiry of the timer using any of the following options:
limiting the number of timer resets triggered by LP-WUR's wake-up indications. For example, reception of an n^{th}>Nₘₐₓ LP-WUR's indication will not result in a reset of the timer.
limiting the maximum duration between two consecutive reset indications. For example, a LP-WUR's wake-up indication received after a time duration Tₘₐₓ from the last indication will not result in a reset of the timer.

The example scenario shown in FIG. 22 illustrates two cases in the RRC IDLE/INACTIVE state: a false alarm triggered main radio wake-up and a true alarm triggered main radio wake-up. In the first case from left, a false LP-WUS is detected by the LP-WUR and a wake-up indication is signaled to the main radio, which subsequently initiates transition from “ultra-deep sleep” power state to active power state and initiates the, e.g., LP-WUS-to-PO offset, timer. During main radio's ramp-up and synchronization, a true LP-WUS is detected by the LP-WUR and another wake-up indication is signaled to the main radio. The main radio, then, resets the timer which subsequently extends the total duration the main radio stays in an active power state, e.g., extends the number of POs to be monitored by the main radio. The main radio monitors a first PO and determines that it does not contain any paging messages addressed to itself or its UE group, i.e., the first wake-up indication is a result of a false LP-WUR alarm. The main radio, then, monitors a second PO and detects a paging message addressed to itself, i.e., the second wake-up indication is a result of a true LP-WUS detection, and initiates an RRC connection. In the second case from left, a true LP-WUS is detected by the LP-WUR and a wake-up indication is signaled to the main radio, which subsequently initiates transition from “ultra-deep sleep” power state to active power state and initiates the, e.g., LP-WUS-to-PO offset, timer. The main radio monitors a first PO at the expiry of the timer and detects a paging message addressed to itself, i.e., the wake-up indication is a result of a true LP-WUS detection, and initiates an RRC connection.

Note that a similar example embodiment may apply to LP-WUS monitoring in RRC CONNECTED state where LP-WUS detection triggers main radio's transition from sleep power states other than “ultra-deep sleep” power state, e.g., light sleep, power state and main radio's monitoring of PDCCH, e.g., according to a C-DRX or UE-specific search space configuration.

In an embodiment, the power states of the main radio may be as shown in Table 1 below:

TABLE 1

| Power | | Relative |
|---|---|---|
| State | Characteristics | Power |
| Deep Sleep | Time interval for the sleep should be larger than | 1 |
| | the total transition time entering and leaving this | (Optional: |
| | state. Accurate timing may not be maintained. | 0.5) |
| Light Sleep | Time interval for the sleep should be larger than | 20 |
| | the total transition time entering and leaving this | |
| | state. | |
| Micro sleep | Immediate transition is assumed for power | 45 |
| | saving study purpose from or to a non-sleep state | |
| PDCCH-only | No PDSCH and same-slot scheduling; this | 100 |
| | includes time for PDCCH decoding and any | |
| | micro-sleep within the slot. | |
| SSB or | SSB can be used for fine time-frequency sync. | 100 |
| CSI-RS proc. | and RSRP measurement of the serving/camping | |
| | cell. TRS is the considered CSI-RS for sync. FFS | |
| | the power scaling for processing other | |
| | configurations of CSI-RS. | |
| PDCCH + | PDCCH + PDSCH. ACK/NACK in long PUCCH is | 300 |
| PDSCH | modeled by UL power state. | |
| UL | Long PUCCH or PUSCH. | 250 (0 dBm) |
| | | 700 (23 dBm) |

Table 2 below shows the sleep states, additional transitional energy and total transition time.

TABLE 2

| | Additional transition energy: | Total |
|---|---|---|
| Sleep type | (Relative power x ms) | transition time |
| Deep sleep | 450 | 20 ms |
| Light sleep | 100 | 6 ms |
| Micro sleep | 0 | 0 ms* |

*Immediate transition is assumed for power saving study purpose from or to a non-sleep state

Table 3 below shows a definition of ultra-deep sleep in accordance with an embodiment.

| | | | | |
|---|---|---|---|---|
| | | Ramp-up and down | | |
| | | transition energy | | |
| Power | Relative | (Note1): (unit | Ramp-up | Time for |
| State | Power (unit) | multiplied by ms) | time | sync/re-sync |

| | | | |
|---|---|---|---|
| Ultra- | 0.015 | For evaluation, at least for FR1 MR ultra- | For MR, at least for |
| deep | | deep sleep state, (Ramp-up and down | FR1 evaluation, |
| sleep | | transition energy, ramp-up time) is as | Number of SSBs |
| | | follows, | for sync/re-sync |
| | | Alt 1: (15000, 400 ms) as baseline | for MR is up to 10 |
| | | Alt 2: (40000, 800 ms) | Companies to report |
| | | Company to report which alternative they | timeline and energy |
| | | use for which use cases. | consumption |

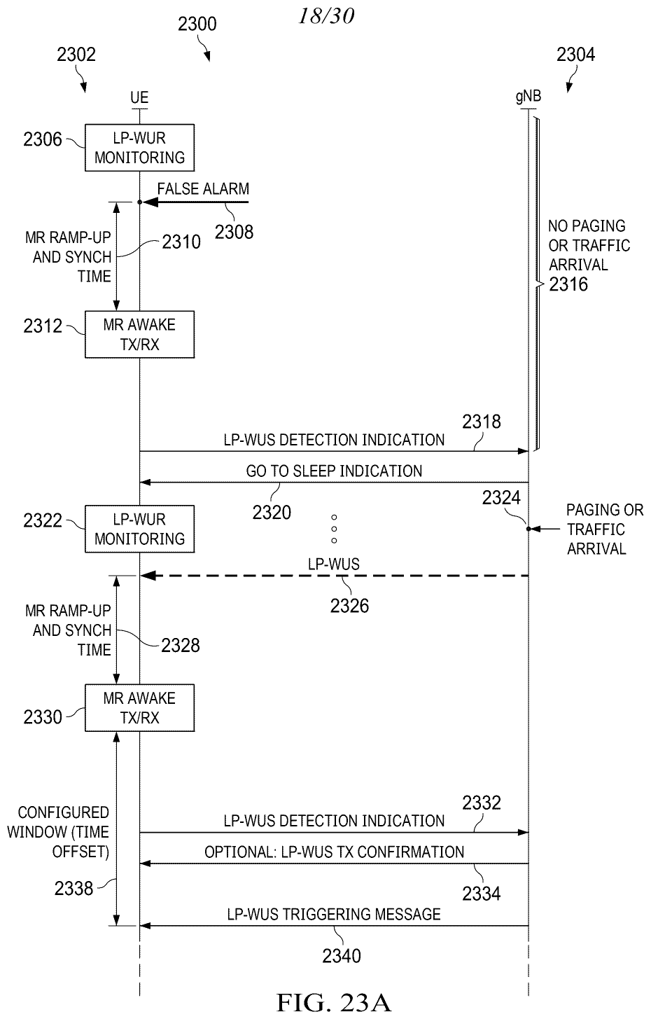

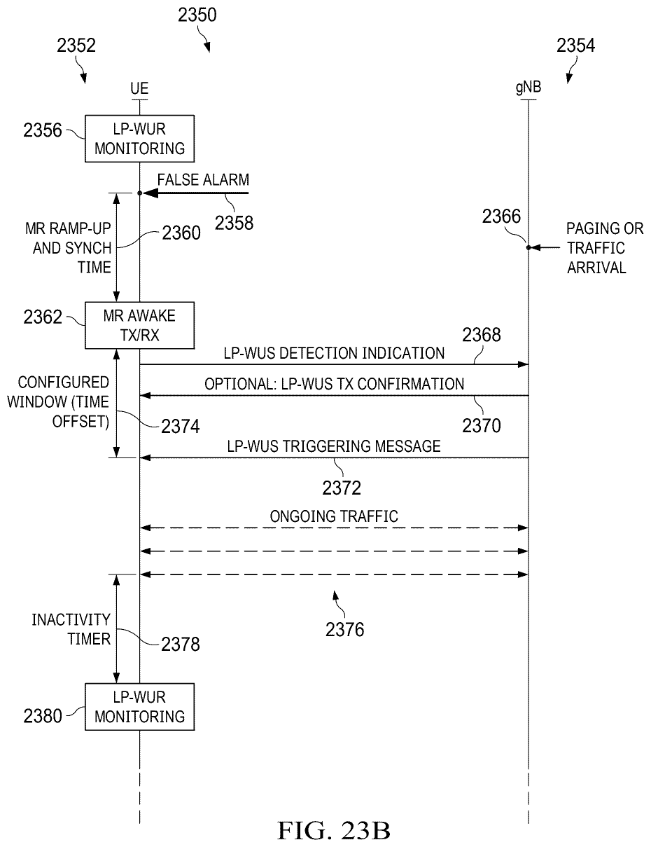

FIG. 23A is a message flow diagram of a method 2300 for waking up a sleeping UE using a LP WUS in accordance with an example embodiment. Method 2300 shows an example of a UE 2302 and a gNB 2304 exchanging messages. The UE 2302 is configured with a set of timers and/or signaling exchange to trade-off network resource overhead and UE power consumption by allowing the main radio to signal a detection indication to the NW upon LP-WUS detection. The network can signal: 1) a “go to sleep” indication to the UE if LP-WUS detection was due to a false alarm; or 2) “TX confirmation” and/or “LP-WUS triggering message” if the LP-WUS detection is true or paging is available for the UE/UE-group. This method therefor also avoids any latency that might result from false alarm triggered miss-detections and can reduce resource overhead (LP-WUS resources>MR indication resources).

At step 2306, the UE 2302 monitors LP-WUS. At step 2308, the UE 2302 detects a false alarm (although, at this time, the UE 2302 does not know if it is a valid wake up alarm or a false wake up alarm). After the expiration of MR ramp-up and synch time (step 2310), the main radio Tx/Rx awakes (step 2312). The UE 2302 sends a LP-WUS detection indication (step 2318) which the gNB 2304 receives after a period of no paging or traffic arrival (step 2316). The gNB 2304 then sends a go to sleep indication to the UE 2302 (step 2320). The UE 2302 then puts the main radio back to sleep and begins LP-WUS monitoring with the low power radio (step 2322). At step 2324, the gNB receives paging of traffic arrival and then sends the UE 2302 a LP-WUS (step 2326). After the expiration of main radio ramp-up and synchronization time (step 2328), the main radio Tx/Rx awakens (step 2330). The UE 2302 sends a LP-WUS detection indication message (step 2332) to the gNB 2304. The gNB 2304 then optionally sends a LP-WUS TX confirmation message (step 2334) to the UE 2302. The gNB 2304 then sends an LP-WUS triggering message (step 2340) which is received by the UE 2302 before the expiration of the configured window (time offset) (step 2338).

FIG. 23B is a message flow diagram of a method 2350 for waking up a sleeping UE using a LP WUS in accordance with an example embodiment. Method 2350 shows an example of a UE 2352 and a gNB 2354 exchanging messages. The UE 2352 is configured with a set of timers and/or signaling exchange to trade-off network resource overhead and UE power consumption by allowing the main radio to signal a detection indication to the NW upon LP-WUS detection. The network can signal: 1) a “go to sleep” indication to the UE if LP-WUS detection was due to a false alarm; or 2) “TX confirmation” and/or “LP-WUS triggering message” if the LP-WUS detection is true or paging is available for the UE/UE-group. This method therefor also avoids any latency that might result from false alarm triggered miss-detections and can reduce resource overhead (LP-WUS resources>MR indication resources).

At step 2356, the UE 2352 monitors LP-WUS using a LP-WUR. At step 2358, the UE 2352 detects a false alarm (although, at this time, the UE 2302 does not know if it is a valid wake up alarm or a false wake up alarm). After the expiration of MR ramp-up and synch time (step 2360), the main radio Tx/Rx awakes (step 2362). The UE 2352 sends a LP-WUS detection indication (step 2068) which the gNB 2354 receives after a period of no paging or traffic arrival (step 2366). During the configured window (time off set) 2374, the gNB 2354 then optionally sends an LP-WUS TX confirmation message to the UE 2352 (step 2370). At step 2372, also during the configured window (time off set) 2374, the gNB 2354 sends an LP-WUS triggering message to the UE 2352. The UE 2352 and the gNB 2354 then engage in ongoing traffic (step 2376) with each other. After the expiration of an inactivity timer (step 2378), the UE 2352 puts the main radio to sleep and begins LP-WUS monitoring (step 2380) with the LP-WUR.

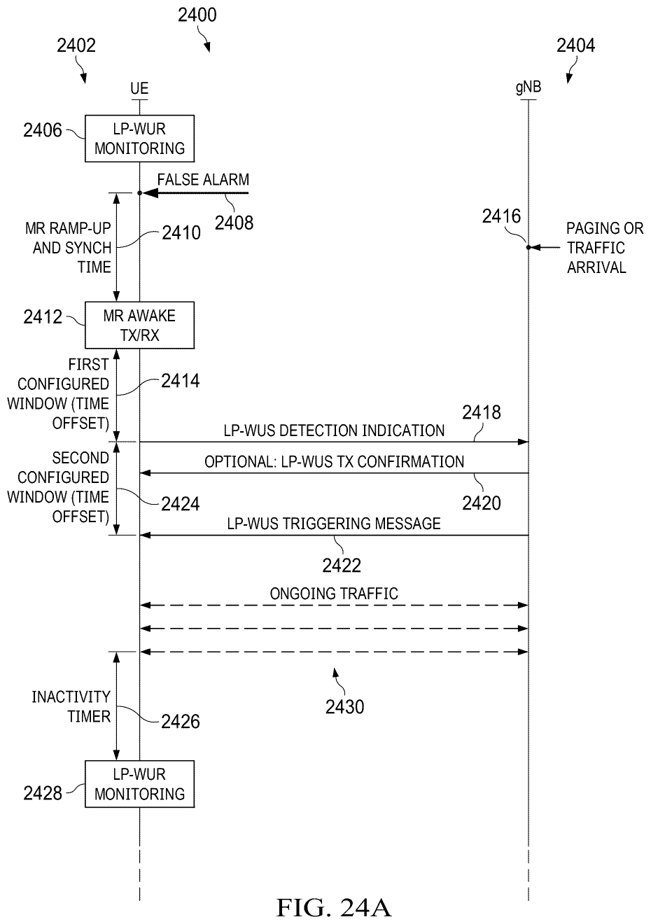

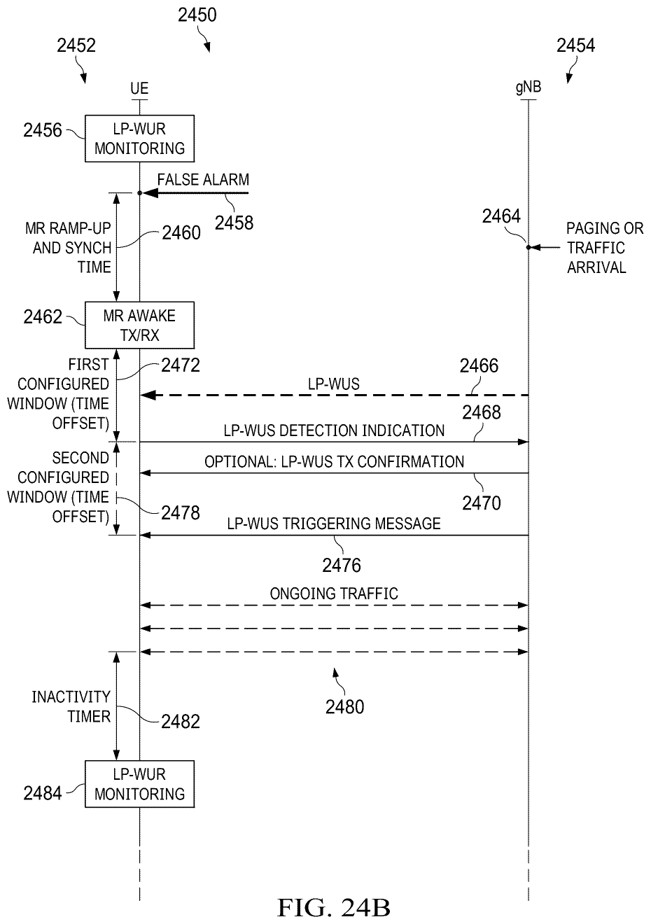

FIG. 24A is a message flow diagram of a method 2400 for waking up a sleeping UE using a LP WUS in accordance with an example embodiment. Method 2400 shows an example of a UE 2402 and a gNB 2404 exchanging messages. The UE 2402 is configured with a set of timers and/or signaling exchange to trade-off network resource overhead and UE power consumption by allowing the main radio to signal a detection indication to the NW upon LP-WUS detection. The network can signal: 1) a “go to sleep” indication to the UE if LP-WUS detection was due to a false alarm; or 2) “TX confirmation” and/or “LP-WUS triggering message” if the LP-WUS detection is true or paging is available for the UE/UE-group. This method therefor also avoids any latency that might result from false alarm triggered miss-detections and can reduce resource overhead (LP-WUS resources>MR indication resources).

At step 2406, the UE 2402 monitors LP-WUS. At step 2408, the UE 2402 detects a false alarm (although, at this time, the UE 2402 does not know if it is a valid wake up alarm or a false wake up alarm). After the expiration of MR ramp-up and synch time (step 2410), the main radio Tx/Rx awakes (step 2412). After the expiration of a first configured window (time offset) (step 2414), the UE 2402 sends an LP-WUS detection indication (step 2418) which the gNB 2404 receives after receiving a paging or traffic arrival indication (step 2416). During the second configured window (time off set) 2424, the gNB 2450 then optionally sends an LP-WUS TX confirmation message to the UE 2402 (step 2420). At step 2422, also during the second configured window (time off set) 2424, the gNB 2404 sends an LP-WUS triggering message to the UE 2402 (step 2422). In an embodiment, if the UE 2402 receives an LP-WUS triggering message during the first configured window (2414), the UE 2402 does not send a LP-WUS detection indication in step 2418. The UE 2402 and the gNB 2404 then engage in ongoing traffic (step 2430) with each other with the UE 2402 utilizing the main radio for this ongoing traffic. After the expiration of an inactivity timer (step 2426), the UE 2402 puts the main radio to sleep and begins LP-WUR monitoring (step 2428) with the LP-WUR.

FIG. 24B is a message flow diagram of a method 2450 for waking up a sleeping UE using a LP WUS in accordance with an example embodiment. Method 2450 shows an example of a UE 2452 and a gNB 2454 exchanging messages. The UE 2452 is configured with a set of timers and/or signaling exchange to trade-off network resource overhead and UE power consumption by allowing the main radio to signal a detection indication to the NW upon LP-WUS detection. The network can signal: 1) a “go to sleep” indication to the UE if LP-WUS detection was due to a false alarm; or 2) “TX confirmation” and/or “LP-WUS triggering message” if the LP-WUS detection is rue or paging is available for the UE/UE-group. This method therefor also avoids any latency that might result from false alarm triggered miss-detections and can reduce resource overhead (LP-WUS resources>MR indication resources).

At step 2456, the UE 2452 monitors LP-WUS. At step 2458, the UE 2452 detects a false alarm (although, at this time, the UE 2452 does not know if it is a valid wake up alarm or a false wake up alarm). Before the expiration of a first configured window (time offset) (step 2472), and after receiving a paging or traffic arrival indication (step 2464), the gNB 2454 sends a LP-WUS message to the UE 2452 (step 2466). Also during the first configured window 2472, the UE 2452 sends an LP_WUS detection indication to the gNB 2454 (step 2468). The gNB 2454 then optionally sends an LP-WUS TX confirmation message to the UE 2452 during a second configured window (time offset) 2478 (step 2470). The gNB 2454 then sends an LP-WUS triggering message to the UE 2452 during the second configured window (time offset) 2478 (step 2476). The UE 2452 and the gNB 2454 then engage in ongoing traffic with each other (step 2480). After the expiration of an inactivity timer (step 2482), the UE 2452 puts the main radio to sleep and begins LP-WUS monitoring (step 2484) with the LP-WUR.

In the example scenarios shown in FIGS. 23A and B and FIGS. 24A and B, two cases are illustrated. In the first case exemplified in FIG. 23A, the main radio transmits a signal to the network upon the detection of a LP-WUS where the detection may be due to a false alarm or a true alarm (a valid WUS). The transmitted signal is used to indicate to the network that a LP-WUS was detected by a LP-WUR, and the transmitted signal can be any of a PRACH preamble on a PRACH occasion, a first indication in a MAC CE, and a first indication in an RRC message. The main radio may then, in a first alternative highlighted in FIG. 23B, receive a second indication to monitor for any of a paging DCI, a paging message, and an RRC message. The second indication may be explicit in the form of, e.g., an early paging indication (PEI) or a sequence, or implicit, e.g., through reception of a LP-WUS triggering message/signal (such as a DCI scrambled by a paging RNTI or a UE configured RNTI) at a configured/predetermined time offset from when the first indication was transmitted. The main radio may then, in a second alternative highlighted in FIG. 23A, receive a second indication to transition to a sleep power state. The second indication may be any of a newly defined DCI, a sequence, and an element in an existing DCI.

In the second case exemplified in FIG. 24A, the main radio transmits a signal to the network at a configured/predetermined first time offset after the detection of a LP-WUS where the detection may be due to a false alarm or a true alarm (valid WUS). The transmitted signal is used to indicate to the network that a LP-WUS is detected by a LP-WUR and the transmitted signal can be any of a PRACH preamble on a PRACH occasion, a first indication in a MAC CE, and a first indication in an RRC message. The signal may only be transmitted if the main radio fails to detect a DCI scrambled by a paging RNTI or a UE configured RNTI for the duration of the first time offset. The main radio may then, in a first alternative highlighted in FIG. 24B, receive a second indication to monitor for any of a paging DCI, a paging message, and an RRC message. The second indication may be explicit in the form of, e.g., an early paging indication (PEI) or a DCI of format 2_6 (i.e., WUS for RRC connected state) or a sequence, or implicit, e.g., through reception of a DCI scrambled by a paging RNTI or a UE configured RNTI at a configured second time offset from when the first indication was transmitted. The main radio may then, in a second alternative highlighted in FIG. 22(a), receive a second indication to transition to a sleep power state.

### 4.2.2 Repetitive LP-WUS Transmission

The repetitive LP-WUS transmission scheme described herein can mitigate the impact of LP-WUR's false alarms on latency and UE's power consumption, but at the expense of network's resource overhead. The scheme is illustrated in FIG. 21, where instead of the UE extending its duration in the active power state, e.g., duration of main radio's monitoring of POs, the gNB/network repeats the transmission of LP-WUS triggered signals, e.g., paging messages over configured POs, for a duration that corresponds to at least the time from the first opportunity available for the transmission of the signal, e.g., first PO available for monitoring based on main radio configuration, to the opportunity following the end of a configured time offset from, e.g., when the LP-WUS is actually transmitted. The configured time offset, e.g., LP-WUS-to-PO offset, may be used to capture the expected time to be taken by the main radio to transition from a non-active, e.g., “ultra-deep sleep”, power state to an active power state which includes the time for the main radio to ramp-up and perform synchronization.

Note that the scheme as described so far may not be suitable for a case when the main radio is configured to monitor a LP-WUS triggered signal, e.g., paging message, at an offset from when the LP-WUS is detected and the LP-WUR is configured to perform ‘always-on’/‘continuous’ or very short ‘duty-cycle’ monitoring. This might be due to the expected increase in network resource overhead associated with an expected large number of transmission repetition. For example, the network might be required to repeat the transmission of a paging message every subframe from when the LP-WUS is transmitted until the end of the time expected for a main radio to ramp-up and perform synchronization which can be a significant overhead for a relatively long main radio ramp-up and synchronization time. Such an increase in overhead can be avoided by limiting the opportunities available for LP-WUS triggered signals transmission to slots, subframes, and/or frames that are determined based on, e.g., an assigned UE identifier or another LP-WUS identifier configured by the network using any of RRC signaling and System Information, i.e., opportunities are not identified by timing of LP-WUS detection. Note also that the overhead may be tolerated when this scheme is used for LP-WUS monitoring that triggers PDCCH monitoring, e.g., based on UE-specific search space(s), by the main radio in the RRC CONNECTED state.

This scheme, however, shall mitigate any increase in the latency experienced by a UE due to false alarm triggered miss-detection, i.e., due to missing the detection of a true LP-WUS transmitted during the main radio's transition to an active power state triggered by a false alarm, without any increase in UE's power consumption.

Note that, in general, a LP-WUR may be aware of the radio frame structure, i.e., depending on LP-WUR implementation. One example is if the LP-WUR may be aware of a TDD configuration, it may not monitor a WUS during uplink periods.

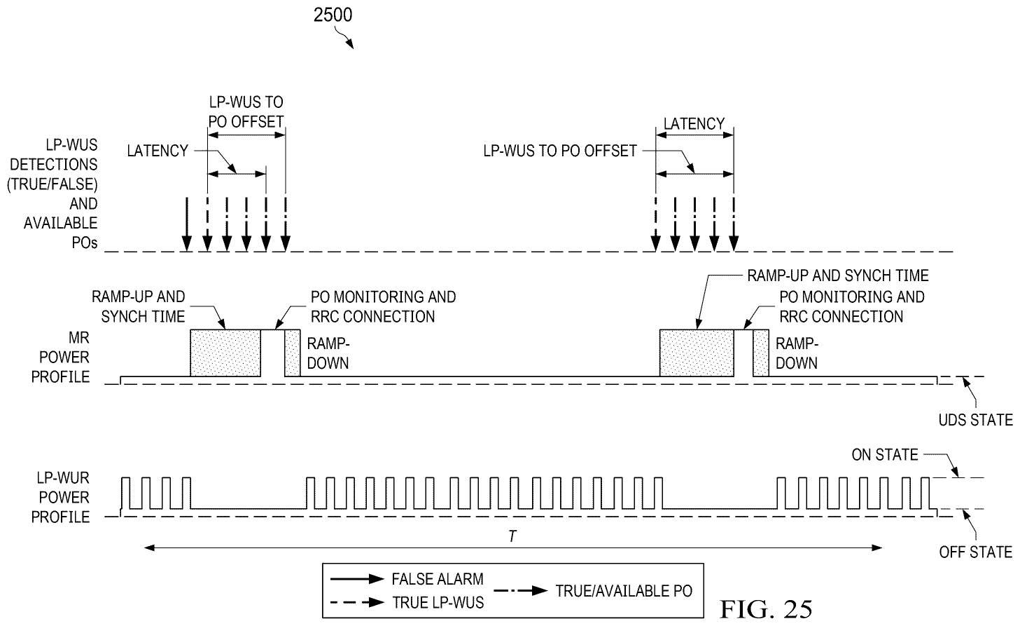

FIG. 25 shows a repetitive LP-WUS transmission operation 2500 in the presence of noise/interference false alarms in accordance with an embodiment. The example scenario shown in FIG. 25 illustrates two cases in the RRC IDLE/INACTIVE state: a false alarm triggered main radio wake-up and a true alarm triggered main radio wake-up.

In the first case from left, a false LP-WUS is detected by the LP-WUR and a wake-up indication is signaled to the main radio, which subsequently initiates transition from “ultra-deep sleep” power state to active power state and initiates the, e.g., LP-WUS-to-PO offset, timer. During main radio's ramp-up and synchronization, a true LP-WUS is actually transmitted by the network but not received by the LP-WUR as it stopped monitoring LP-WUSs after signaling the wake-up indication to the main radio. The main radio is therefore unaware of the true LP-WUS and will monitor the LP-WUS triggered signal, e.g., paging message, at the nearest opportunity based only on the falsely detected LP-WUS and configured timing offset, e.g., expected time for main radio to ramp-up and perform synchronization. However, since the network repeats the transmission of the LP-WUS triggered signal in all available opportunities, e.g., POs, including the one actually monitored by the UE, the main radio detects a paging message addressed to itself and initiates an RRC connection. Therefore, in the first case, the network's repetitive transmission may be utilized for the main radio to detect the paging message at the appropriate time/opportunity without any degradation on experienced latency or power consumption.

In the second case from left, a true LP-WUS is detected by the LP-WUR and a wake-up indication is signaled to the main radio, which subsequently initiates transition from “ultra-deep sleep” power state to active power state and initiates the, e.g., LP-WUS-to-PO offset, timer. The main radio monitors a first PO at the expiry of the timer and detects a paging message addressed to itself and initiates an RRC connection.

It is worth noting that in the example in FIG. 25, the latency associated with the false alarm case is actually shorter than that associated with the case without false alarm.

Note that a similar example embodiment may apply to LP-WUS monitoring in the RRC CONNECTED state where the LP-WUS detection triggers main radio's transition from sleep power states other than “ultra-deep sleep” power state, e.g., light sleep, power state and main radio's monitoring of PDCCH, e.g., according to a C-DRX or UE-specific search space configuration.

### 4.2.3 Limited LP-WUR Duty-Cycle

The limited LP-WUR duty-cycle scheme described herein can eliminate/avoid the false alarm triggered miss-detections without a significant impact on UE's power consumption or network's resource overhead, but at the expense of overall higher experienced latency by the UE.

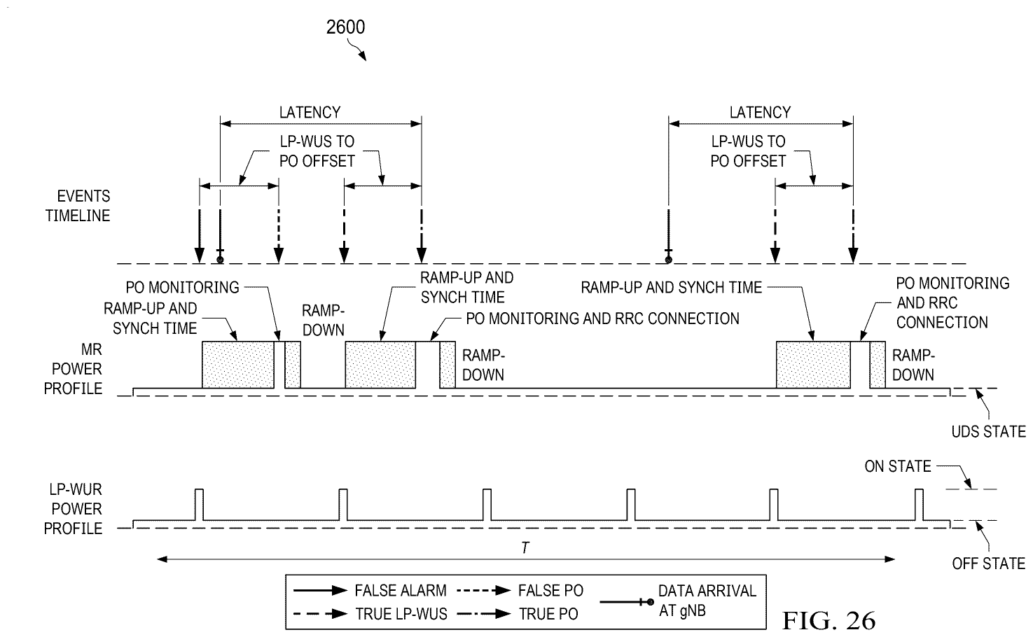

FIG. 26 shows a limited LP-WUR duty-cycle operation 2600 in the presence of noise/interference false alarms in accordance with an embodiment The scheme is illustrated in FIG. 26, where the duty-cycle of the LP-WUR is simply limited to a duration greater than the time required for the main radio to wake-up (including ramp-up and synchronization time), determine a false alarm (e.g., does not detect a paging message addressed to itself or its UE group in a configured PO), and return to a non-active (e.g., ultra-deep sleep) power state. This simple scheme may solve the network's resource overhead issue but will result in an increase in UE's experienced latency. There might still be an impact on UE's power consumption, but might not be as severe as the typical scheme in FIG. 21.

The example scenario shown in FIG. 26 illustrates two cases: data arrival with a false alarm triggered main radio wake-up and data arrival without a false alarm triggered main radio wake-up.

In the first case from left, a false LP-WUS is detected by the LP-WUR and a wake-up indication is signaled to the main radio, which subsequently initiates transition from “ultra-deep sleep” power state to active power state and initiates the, e.g., LP-WUS-to-PO offset, timer. During main radio's ramp-up and synchronization, data/paging intended to the UE arrives at the network but a LP-WUS cannot be transmitted by the gNB due to the LP-WUR's duty cycle and LP-WUS transmission is scheduled for the next cycle. Note that in this case latency has increased due to the use of a long LP-WUR duty cycle and further the total power consumed by the main radio to ramp-up and perform synchronization is lost, i.e., does not result in any benefit to the UE as the main radio will have to ramp-up and perform synchronization again upon the reception of the true LP-WUS in the following LP-WUR cycle.

In the second case from left, i.e., first case from right, a true LP-WUS is detected by the LP-WUR and a wake-up indication is signaled to the main radio, which subsequently initiates transition from “ultra-deep sleep” power state to active power state and initiates the, e.g., LP-WUS-to-PO offset, timer. The main radio monitors a first PO at the expiry of the timer and detects a paging message addressed to itself and initiates an RRC connection. Note that data arrival at network is the same for both cases and latency experienced when false alarms are detected and not detected by the LP-WUR are the same, despite being in general higher than the other schemes presented in Section 4.2.1 and Section 4.2.2. Further, it is noted that false alarm triggered miss-detection are avoided in this scheme without an impact on network's resource overhead.

Note that the representation of latency in FIG. 21, FIG. 22, and FIG. 25 ignores the time from actual data arrival at gNB to LP-WUS transmission assuming that the LP-WUR's duty-cycle is much shorter than the main radio's Ramp-up and Synchronization time. However, in FIG. 26, the time from actual data arrival at gNB to LP-WUS transmission is not ignored since the LP-WUR's duty-cycle is comparable in duration to the main radio's Ramp-up and Synchronization time.

### 4.3Procedures to Support False Alarm Handling Schemes

In this section, signaling and procedures to enable efficient use of the embodiment schemes to handle LP-WUS false alarm triggered miss-detections with proper trade-off between UE power consumption, UE experienced latency, and network resource utilization/overhead.

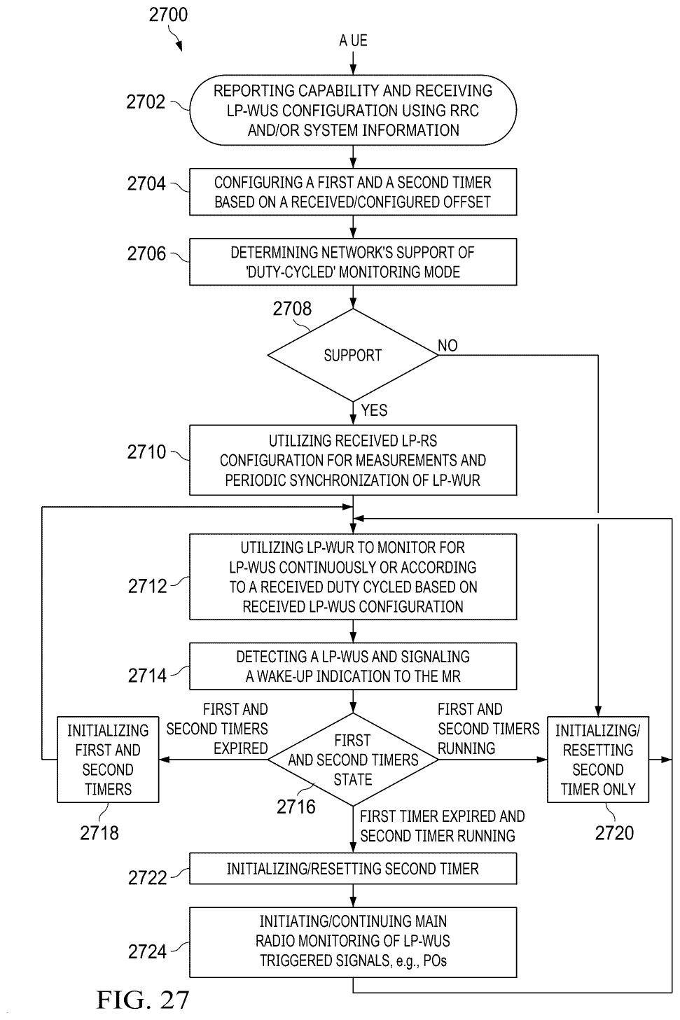

FIG. 27 shows an example flow chart of a method 2700 illustrating a UE utilizing a LP-WUR to monitor for LP-WUS concurrently while main radio is operating in accordance with an embodiment. In method 2700, a UE is equipped with a LP-WUR that can operate concurrently with the main radio according to a scheme described in FIG. 20. To begin, the UE transmits its LP-WUR capability and receives, in step 2702, LP-WUS/LP-WUR configuration using any of RRC and system information signaling. The LP-WUS/LP-WUR configuration may include any of:
A support indication of a monitoring mode, e.g., ‘duty-cycled’, which may require network's transmission of periodic reference signals, e.g., beacons.
A duty cycle configured as an indication to one of a set of preconfigured values or as a number of, e.g., slots, subframes, frames.
An offset indicating the minimum duration between LP-WUS transmission and a first main radio signaling opportunity/occasion, e.g., PO.
A periodic low power reference signal (LP-RS), e.g., beacon, configuration.
LP-WUS transmission configuration including, e.g., data rate, coding scheme, coding rate, and synchronizing/triggering preamble.

Next, at step 2704, the UE configures a first and a second timer based on the received/configured offset. The first timer is set to an offset time that it takes for the main radio to wake up. The LP-WUR needs to stay active and continue to monitor for LP-WUS during this time period measured by the first timer. The second timer is determined based on the monitoring duration during which the main radio will stay active in a powered up state and actively monitor for signals from the gNB. After the expiry of the second timer, if no signals have been received indicating that the main radio should remain active, the main radio will go back to sleep and the LP-WUR will begin monitoring for LP-WUS. In various embodiments, the timers may be determined by parameters specified in a standard. The parameters may include, for example, a time offset between LP-WUS detection and signals/channels transmission intended to MR and a minimum number or duration of monitoring occasions for MR upon wake-up. The UE, in step 2704, determines network's support of ‘duty-cycled’ monitoring mode. At step 2708, if the network does not support “duty cycled” monitoring mode, then the method 2700 proceeds to step 2720. If, at step 2708, the network does support “duty cycled” monitoring mode, then the method 2700 proceeds to step 2710. At step 2710, the UE utilizes LP-RS configuration for measurements and periodic synchronization of the LP-WUR. At step 2712, the LP-WUR monitors for LP-WUS based on the received/configured duty cycle and LP-WUS transmission configuration. At step 2714, the LP-WUR detects a LP-WUS and signals a wake-up indication to the main radio. At step 2716, on a first condition that the first and the second timers expired, the UE in step 2718 initializes the first and the second timers and then the method 2700 proceeds back to step 2712. Alternatively, at step 2716, on a second condition that the first and the second timers are running, the UE resets only the second timer at step 2720, after which, the method 2700 returns to step 2712. Alternatively, on a third condition that the first timer expired and the second timer is running, the UE resets only the second timer at step 2722. At step 2724, the main radio monitors for LP-WUS triggered signals, e.g., POs, after expiry of the first timer and while the second timer is running, after which, the method 2700 proceeds back to step 2712.

The LP-WUR capability may include any of the following information elements:
Supported/desired monitoring modes, e.g., ‘continuous’ and/or ‘duty-cycled’ monitoring.
Indication of support of, e.g., ‘short’ and/or ‘long’, ‘duty-cycled’ monitoring.
Supported/desired LP-WUS false alarm rates (FARs).
Required timing offset between LP-WUS detection until LP-WUR's signaling of wake-up indication to the main radio.
Required timing offset between main radio's reception of a wake-up indication till it is ready to monitor LP-WUS triggered signals.

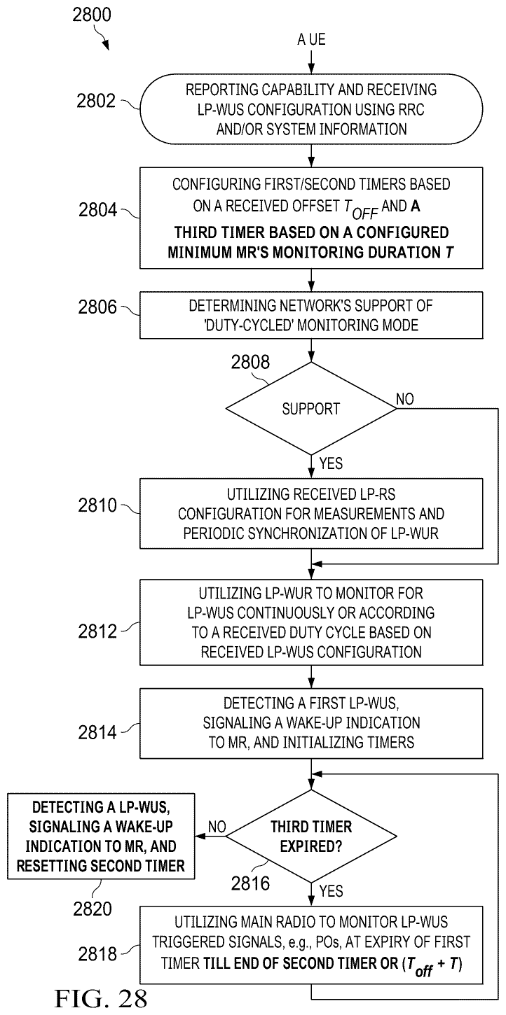

FIG. 28 shows an example flow chart of a method 2800 illustrating a UE utilizing a LP-WUR to monitor for LP-WUS concurrently while main radio ramps-up and synchronizes for reception of LP-WUS triggered signals in accordance with an embodiment. In the embodiment exemplified in FIG. 28, a UE is equipped with a LP-WUR that can operate concurrently with the main radio and both of the schemes described in FIG. 21 and FIG. 22 are considered. At step 2802, the UE transmits its LP-WUR capability and receives, in a first step, LP-WUS/LP-WUR configuration using any of RRC and system information signaling. The LP-WUS/LP-WUR configuration may include any of:
A support indication of a monitoring mode, e.g., ‘duty-cycled’, which may require network's transmission of periodic reference signals, e.g., beacons.
A duty cycle configured as an indication to one of a set of preconfigured values or as a number of, e.g., slots, subframes, frames.
A first offset indicating the minimum duration between LP-WUS transmission and a first main radio signaling opportunity/occasion, e.g., PO.
A second offset indicating the maximum duration between LP-WUS transmission and a first main radio signaling opportunity/occasion, e.g., PO.
A minimum duration required for the main radio to monitor for LP-WUS triggered signals, e.g., POs. The duration may be mandated by the network to control resource overhead, e.g., associated with retransmissions due to miss-detection, based on UE's supported FAR and LP-WUS transmission configuration.
A periodic low power reference signal (LP-RS), e.g., beacon, configuration.
LP-WUS transmission configuration including, e.g., data rate, coding scheme, coding rate, and synchronizing/triggering preamble.

At step 2804, the UE determines network's support of ‘duty-cycled’ monitoring mode. At step 2806, the UE configures first/second timers based on the received/configured first offset T_{off} and a third timer based on any of the received/configured second offset and minimum main radio's monitoring duration T. At step 2808, if the network supports “duty cycled” monitoring, the method 2800 proceeds to step 2810 and if it does not the method 2800 proceeds to step 2818. At step 2810, the UE utilizes LP-RS configuration for measurements and periodic synchronization of the LP-WUR. At step 2812, the LP-WUR monitors for LP-WUS based on received/configured duty cycle and LP-WUS transmission configuration. At step 2814, the LP-WUR detects a first LP-WUS, signals a first wake-up indication to the main radio, and initializes the first, the second, and the third timers. At step 2816 the method proceeds to step 2818 if a 3^{rd} time has expired and proceeds to step 2820 if the 3^{rd} time has not expired. At step 2820, the LP-WUR detects a second LP-WUS before the expiry of the first and the third timers, signals a second wake-up indication to the main radio, and resets the second timer. In an alternative to the step 2820, at step 2818, the LP-WUR detects a second LP-WUS after the expiry of the third timer and continues, e.g., incrementing or decrementing, the second timer. Alternatively, the LP-WUR stops monitoring for LP-WUS at the expiry of the third timer. In an eighth step, the main radio monitors for LP-WUS triggered signals, e.g., POs, at expiry of the first timer and until the end of a duration that is determined by the expiry of the second timer or an (T_{off}+T) offset from the detection of the first LP-WUS which can be realized as, e.g., expiry of the third timer after being reset at the expiry of the first timer.

In an alternative to step 2804, the UE determines network's support of ‘continuous’/‘always-on’ monitoring mode. Subsequently, the LP-WUR monitors for LP-WUS continuously based on received LP-WUS transmission configuration and synchronizing/triggering preamble.

The LP-WUR capability may include any of the following information elements:
Supported/desired monitoring modes, e.g., ‘continuous’ and/or ‘duty-cycled’ monitoring.
Indication of support of, e.g., ‘short’ and/or ‘long’, ‘duty-cycled’ monitoring.
Supported/desired LP-WUS false alarm rates (FARs).
Required timing offset between LP-WUS detection till LP-WUR's signaling of wake-up indication to the main radio.
Required timing offset between main radio's reception of a wake-up indication till it is ready to monitor LP-WUS triggered signals.
Indication of support of concurrent operation of LP-WUR and any of MR's ramp-up, MR's synchronization, and MR's monitoring of LP-WUS triggered signals.

Note that the main radio initiates ramp-up and synchronization procedure upon reception of a wake-up indication from the LP-WUR. Additionally, the second offset indicating the maximum duration between LP-WUS transmission and a first main radio signaling opportunity/occasion, e.g., PO, can be used by the UE to determine the number of LP-WUS triggered signaling opportunities within the configured minimum duration required for the main radio to monitor for LP-WUS triggered signals. Alternatively, the second offset can be used in conjunction with another parameter, i.e., indicating the minimum number of LP-WUS triggered signaling opportunities to be monitored by the main radio, to determine the minimum duration required for the main radio to monitor for those signals. Further, the minimum duration required for the main radio to monitor LP-WUS triggered signals may be dependent on UE's capability of concurrent LP-WUR and main radio operation when the main radio is performing any of ramp-up, synchronization, and monitoring of LP-WUS triggered signals. It is also worth mentioning that the value of the third timer may be less than or equal to the value of the first timer.

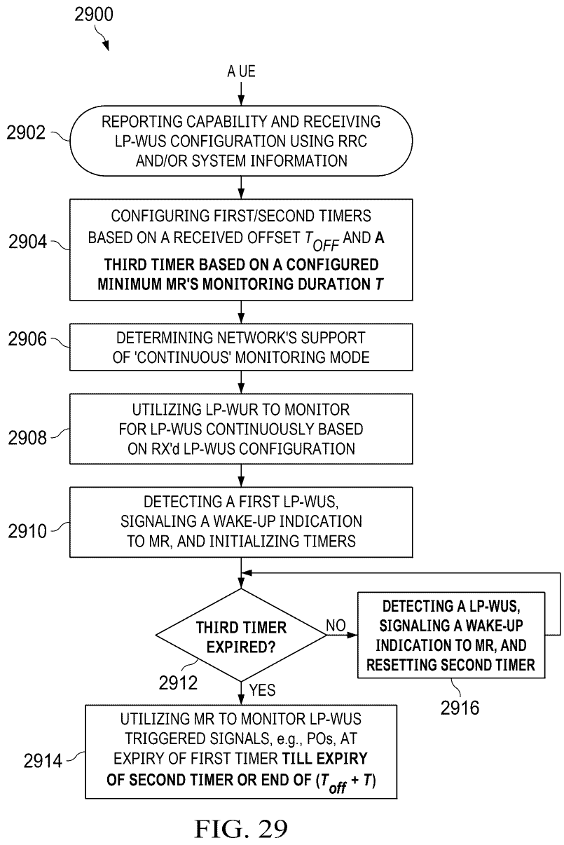

FIG. 29 shows another example flow chart of a method 2900 illustrating a UE utilizing a LP-WUR to continuously monitor for LP-WUS concurrently while main radio ramps-up and/or synchronizes for reception of LP-WUS triggered signals in accordance with an embodiment. In the embodiment exemplified in FIG. 29, a UE is equipped with a LP-WUR that can operate concurrently with the main radio and both of the schemes described in FIG. 22 and FIG. 25 are considered. At step 2902, the UE transmits its LP-WUR capability and receives, in a first step, LP-WUS/LP-WUR configuration using any of RRC and system information signaling. The LP-WUS/LP-WUR configuration may include any of:
A support indication of a monitoring mode, e.g., ‘always-on’/‘continuous’, which alleviates network's requirement to transmit periodic reference signals, e.g., beacons.
A first offset indicating the minimum duration between LP-WUS transmission and a first main radio signaling opportunity/occasion, e.g., PO.
A second offset indicating the maximum duration between LP-WUS transmission and a first main radio signaling opportunity/occasion, e.g., PO.
A minimum duration (as in the scheme described in Section 4.2.1) required for the main radio to monitor for LP-WUS triggered signals, e.g., POs. The duration may be mandated by the network to control resource overhead, e.g., associated with network's retransmission of LP-WUS triggered signals (as in the scheme described in Section 4.2.2).
LP-WUS transmission configuration including, e.g., data rate, coding scheme, coding rate, and synchronizing/triggering preamble.

At step 2904, the UE determines network's support of ‘continuous’ monitoring mode. At step 2906, the UE configures first/second timers based on the received/configured first offset T_{off} and a third timer based on any of the received/configured second offset and minimum main radio's monitoring duration T. Alternatively, at step 2906, the UE configures first timer based on any of the received/configured first offset T_{off} and the main radio's ramp-up & synchronization time. At step 2908, the LP-WUR monitors for LP-WUS based on received LP-WUS configuration. At step 2910, the LP-WUR detects a first LP-WUS, signals a first wake-up indication to the main radio, and initializes at least the first timer and, in some embodiments, initializes the second and the third timers as well. At step 2917, if the 3^{rd} timer has not expired, then the method 2900 proceeds to step 2916 where the LP-WUR detects a second LP-WUS before the expiry of the first and the third timers, signals a second wake-up indication to the main radio, and resets the second timer. At step 2917, if the 3^{rd} timer has expired, then the method 2900 proceeds to step 2914 where the main radio monitors for LP-WUS triggered signals, e.g., POs, at expiry of the first timer and until the end of a duration that is determined by the expiry of the second timer or an (T_{off}+T) offset from the detection of the first LP-WUS.

Note that the main radio initiates ramp-up and synchronization procedure upon reception of a wake-up indication from the LP-WUR. Further, the minimum duration required for the main radio to monitor LP-WUS triggered signals may be dependent on UE's capability of concurrent LP-WUR and main radio operation when the main radio is performing any of ramp-up, synchronization, and monitoring of LP-WUS triggered signals.

In another embodiment, a UE is equipped with a LP-WUR and any of the schemes described above are considered. The UE transmits its LP-WUR capability and receives, in a first step, a LP-WUS/LP-WUR configuration using any of RRC and system information signaling. The LP-WUS/LP-WUR configuration may include any of:
A support indication of a monitoring mode, e.g., ‘always-on’/‘continuous’, which alleviates network's requirement to transmit periodic reference signals, e.g., beacons.
A first offset T_{off} indicating the minimum duration between LP-WUS transmission and a first main radio signaling opportunity/occasion, e.g., PO or PDCCH monitoring occasion.
A minimum duration T_{min_1} required for the gNB, i.e., base station, to transmit a LP-WUS transmission (TX) confirmation message or a LP-WUS triggering message, e.g., Paging DCI, Paging message, or a DCI scrambled by C-RNTI, after reception of a LP-WUS detection indication.
A maximum duration T_{max_1} required for the main radio to monitor for a LP-WUS triggering message, e.g., Paging DCI, Paging message, or a DCI scrambled by C-RNTI, after transmission of a LP-WUS detection indication.
LP-WUS transmission configuration including, e.g., data rate, coding scheme, coding rate, and synchronizing/triggering preamble.
LP-WUS detection indication transmission configuration including any of one or more PRACH preambles, one or more PRACH occasions, and one or more MsgA PUSCH Resource.

The UE, in a second step, determines network's support of ‘continuous’ monitoring mode. In a third step, the UE configures first timer based on any of the received/configured first offset T_{off} and the main radio's ramp-up & synchronization time. In a fourth step, the LP-WUR monitors for a LP-WUS based on the received LP-WUS configuration. In a fifth step, after the LP-WUR detects a first LP-WUS, it signals a first wake-up indication to the main radio, and initializes the first timer. In a sixth step, the main radio transmits a LP-WUS detection indication at the end of the first timer and based on the LP-WUS detection indication transmission configuration. In a seventh step, the UE initializes a second timer based on the minimum duration T_{min_1} and a third timer based on the maximum duration T_{max_1}. On a first condition that the main radio receives a Go to Sleep indication from the network at the expiry of the second timer, the UE, in an eighth step, puts the main radio to sleep and initiates/continues monitoring for a LP-WUS using the LP-WUR. On a second condition that the main radio receives a LP-WUS transmission confirmation message from the network at the expiry of the second timer, the UE, in a ninth step, uses the main radio to monitor for LP-WUS triggering messages until the expiry of the third timer.

In another technical realization, the UE, in the seventh step, initializes only the third timer based on the maximum duration T_{max_1}. Then, the UE, in a subsequent step, uses the main radio to monitor for LP-WUS triggering messages until the expiry of the third timer.

In an embodiment, the UE puts the main radio into a sleep power state and uses the LP-WUR to monitor for LP-WUS at the end of the third timer if the main radio fails to detect any of the LP-WUS transmission confirmation and LP-WUS triggering messages. Alternatively, the UE utilizes the main radio for any of RRC connection establishment, RRC connection resume, data reception, data transmission, system information acquisition/update, and RRC connection release procedures at the end of the third timer if the main radio detects any of the LP-WUS transmission confirmation and LP-WUS triggering messages. Subsequently, at the end of any of the aforementioned procedures, the UE puts the main radio into a sleep power state and uses the LP-WUR to continue monitoring for LP-WUS.

In another embodiment, exemplified in FIG. 21, a base station (BS) supports LP-WUS transmission and any of the schemes described in FIG. 20 and FIG. 25. The base station transmits, in a first step, LP-WUS configuration using any of RRC and system information signaling. The LP-WUS configuration may include any of:
A support indication of a monitoring mode, e.g., ‘always-on’/‘continuous’ or ‘duty-cycled’.
A first offset T_{off} indicating the minimum duration between LP-WUS transmission and a first main radio signaling opportunity/occasion, e.g., PO or PDCCH monitoring occasion.
A minimum duration T_{min_1} required for the base station to transmit a LP-WUS transmission (TX) confirmation message or a LP-WUS triggering message, e.g., Paging DCI, Paging message, or a DCI scrambled by C-RNTI, after reception of a LP-WUS detection indication.
A maximum duration T_{max_1} required for the main radio to monitor for a LP-WUS triggering message, e.g., Paging DCI, Paging message, or a DCI scrambled by C-RNTI, after transmission of a LP-WUS detection indication.
LP-WUS transmission configuration including, e.g., data rate, coding scheme, coding rate, and synchronizing/triggering preamble.
LP-WUS detection indication transmission configuration including any of one or more PRACH preambles, one or more PRACH occasions, and one or more MsgA PUSCH Resource.

The BS, in a second step, receives a LP-WUS detection indication from a UE where the indication may be included in any of a UE-specific, UE group-specific, and cell-specific signaling. The BS may then, in a third step, transmit a LP-WUS transmission confirmation message to the UE based on a first condition where the first condition can be any one or more of the following:
The time duration between the reception of the LP-WUS detection indication and the first occasion available for the transmission of a LP-WUS triggering message for any of the UE and the UE group is less than or equal the maximum duration T_{max_1}.
Reception of one or more higher layer message(s) requiring signaling to any of the UE and the UE group where the higher layer message(s) may be received at any time before the reception of the LP-WUS detection indication or up until the end of a duration T_{min_1} after the reception of the LP-WUS detection indication.

Alternatively, the BS may transmit the LP-WUS triggering message directly based on any of the above conditions. Otherwise, the BS may transmit a Go to Sleep indication to the UE to let the main radio enter into a sleep power state, e.g., ultra-deep sleep power state, where the LP-WUR may still be used to monitor for LP-WUS(s).

In another embodiment, the BS transmits, in a first step, LP-WUS configuration as any of the aforementioned elements using any of RRC and system information signaling. The BS, in a second step, receives one or more higher layer message(s) requiring signaling to any of the UE and the UE group. The BS then, in a third step, transmits a LP-WUS to any of the UE and the UE group. In a fourth step, the BS may, in one alternative, monitor for a LP-WUS detection indication at the end of a time offset T_{off} from the transmission of the LP-WUS. In another alternative, the BS monitors for a LP-WUS detection indication from the end of a time offset T_{off} from the transmission of the LP-WUS and for a time duration corresponding to any of T_{max_1} and (T_{max_1}−T_{min_1}). The BS may then, in a fifth step, transmits a LP-WUS transmission confirmation message to the UE, e.g., at the end of a duration T_{min_1} from the reception of the LP-WUS detection indication. Alternatively, the BS may transmit the LP-WUS triggering message directly before the end of a time duration T_{max_1} from the reception of the LP-WUS detection indication.

In another embodiment, exemplified in FIG. 22, a UE is equipped with a LP-WUR and any of the schemes described in FIG. 20 and FIG. 25 are considered. The UE transmits its LP-WUR capability and receives, in a first step, LP-WUS/LP-WUR configuration using any of RRC and system information signaling. The LP-WUS/LP-WUR configuration may include any of:
A support indication of a monitoring mode, e.g., ‘always-on’/′continuous' or ‘duty-cycled’.
A first offset T_{off} indicating the minimum duration between LP-WUS transmission and a first main radio signaling opportunity/occasion, e.g., PO or PDCCH monitoring occasion.
A monitoring duration Tₘₒₙ for the UE to consider before deciding to transmit a LP-WUS detection indication to the network, e.g., BS.
A minimum duration T_{min_1} required for the gNB, i.e., base station, to transmit a LP-WUS transmission (TX) confirmation message or a LP-WUS triggering message, e.g., Paging DCI, Paging message, or a DCI scrambled by C-RNTI, after reception of a LP-WUS detection indication.
A maximum duration T_{max_1} required for the main radio to monitor for a LP-WUS triggering message, e.g., Paging DCI, Paging message, or a DCI scrambled by C-RNTI, after transmission of a LP-WUS detection indication.
LP-WUS transmission configuration including, e.g., data rate, coding scheme, coding rate, and synchronizing/triggering preamble.
LP-WUS detection indication transmission configuration including any of one or more PRACH preambles, one or more PRACH occasions, and one or more MsgA PUSCH Resource.

In a second step, the UE configures a first timer based on any of the received/configured first offset T_{off} and the main radio's ramp-up & synchronization time.

In a third step, the LP-WUR monitors for LP-WUS based on received LP-WUS configuration.

In a fourth step, the LP-WUR detects a first LP-WUS, signals a first wake-up indication to the main radio, and initializes the first timer.

In a fifth step, the main radio monitors for any of a LP-WUS transmission confirmation and a LP-WUS triggering message for a monitoring duration Tₘₒₙ from the end of the first timer.

On a first condition, the main radio transmits a LP-WUS detection indication at or before the end of the monitoring duration based on the LP-WUS detection indication transmission configuration. The first condition can be any one or more of the following:
The time duration between the transmission of the LP-WUS detection indication and the first occasion available for the reception of a LP-WUS triggering message for any of the UE and the UE group is greater than the monitoring duration Tₘₒₙ.
Failure of reception/detection of any of a LP-WUS transmission confirmation and a LP-WUS triggering message for the monitoring duration Tₘₒₙ.
Failure of reception/detection of a LP-WUS by any of the LP-WUR and the main radio for the monitoring duration Tₘₒₙ.

Otherwise, the UE utilizes the main radio for any of RRC connection establishment, RRC connection resume, data reception, data transmission, system information acquisition/update, and RRC connection release procedures upon reception of any of a LP-WUS transmission confirmation and a LP-WUS triggering message. Alternatively, the UE puts the main radio into a sleep power state and continue using the LP-WUR for LP-WUS monitoring if any of the LP-WUS transmission confirmation and the LP-WUS triggering message indicates another target UE within the UE group.

In a seventh step, the UE initializes a second timer based on the minimum duration T_{min_1} and a third timer based on the maximum duration T_{max_1}. On a second condition that the main radio receives a Go to Sleep indication from the network at the expiry of the second timer, the UE puts the main radio to sleep and initiate/continue monitoring for LP-WUS using the LP-WUR. On a third condition that the main radio receives a LP-WUS transmission confirmation message from the network at the expiry of the second timer, the UE uses the main radio to monitor for LP-WUS triggering messages till the expiry of the third timer.

In another technical realization, the UE, in the seventh step, initializes only the third timer based on the maximum duration T_{max_1}. Then, the UE, in a subsequent step, uses the main radio to monitor for LP-WUS triggering messages till the expiry of the third timer.

In an embodiment, the UE puts the main radio into a sleep power state and uses the LP-WUR to monitor for LP-WUS at the end of the third timer if the main radio fails to detect any of the LP-WUS transmission confirmation and LP-WUS triggering messages. Alternatively, the UE utilizes the main radio for any of RRC connection establishment, RRC connection resume, data reception, data transmission, system information acquisition/update, and RRC connection release procedures at the end of the third timer if the main radio detects any of the LP-WUS transmission confirmation and LP-WUS triggering messages. Subsequently, at the end of any of the aforementioned procedures, the UE puts the main radio into a sleep power state and uses the LP-WUR to continue monitoring for LP-WUS.

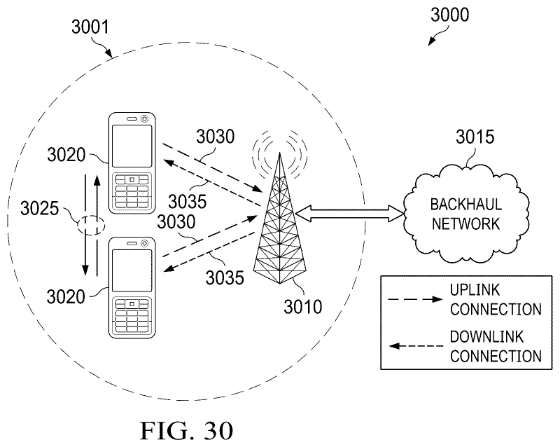

FIG. 30 illustrates an example communications system 3000. Communications system 3000 includes an access node 3010 serving user equipment (UEs) with coverage 3001, such as UEs 3020. In a first operating mode, communications to and from a UE passes through access node 3010 with a coverage area 3001. The access node 3010 is connected to a backhaul network 3015 for connecting to the internet, operations and management, and so forth. In a second operating mode, communications to and from a UE do not pass through access node 3010, however, access node 3010 typically allocates resources used by the UE to communicate when specific conditions are met. Communications between a pair of UEs 3020 can use a sidelink connection (shown as two separate one-way connections 3025). In FIG. 30, the sideline communication is occurring between two UEs operating inside of coverage area 3001. However, sidelink communications, in general, can occur when UEs 3020 are both outside coverage area 3001, both inside coverage area 3001, or one inside and the other outside coverage area 3001. Communication between a UE and access node pair occur over uni-directional communication links, where the communication links between the UE and the access node are referred to as uplinks 3030, and the communication links between the access node and UE is referred to as downlinks 3035.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

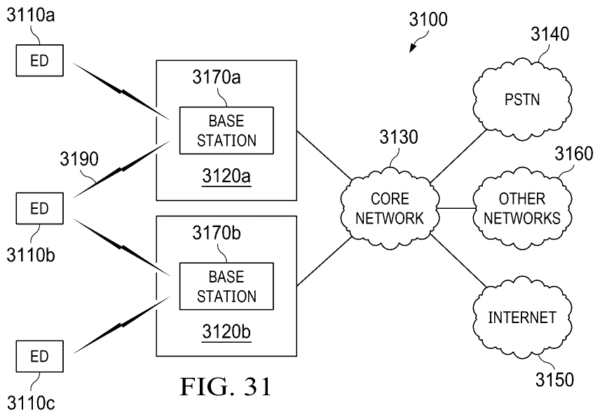

FIG. 31 illustrates an example communication system 3100. In general, the system 3100 enables multiple wireless or wired users to transmit and receive data and other content. The system 3100 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 3100 includes electronic devices (ED) 3110a-3110c, radio access networks (RANs) 3120a-3120b, a core network 3130, a public switched telephone network (PSTN) 3140, the Internet 3150, and other networks 3160. While certain numbers of these components or elements are shown in FIG. 31, any number of these components or elements may be included in the system 3100.

The EDs 3110a-3110c are configured to operate or communicate in the system 3100. For example, the EDs 3110a-3110c are configured to transmit or receive via wireless or wired communication channels. Each ED-3110a-3110c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANS 3120a-3120b here include base stations 3170a-3170b, respectively. Each base station 3170a-3170b is configured to wirelessly interface with one or more of the EDs 3110a-3110c to enable access to the core network 3130, the PSTN 3140, the Internet 3150, or the other networks 3160. For example, the base stations 3170a-3170b may include (or be) one or more of several well-known devices, such as a base transceiver station (BTS), a Node-B (NodeB), an evolved NodeB (eNB), a Next Generation (NG) NodeB (gNB), a gNB centralized unit (gNB-CU), a gNB distributed unit (gNB-DU), a Home NodeB, a Home eNodeB, a site controller, an access point (AP), or a wireless router. The EDs 3110a-3110c are configured to interface and communicate with the Internet 3150 and may access the core network 3130, the PSTN 3140, or the other networks 3160.

In the embodiment shown in FIG. 31, the base station 3170a forms part of the RAN 3120a, which may include other base stations, elements, or devices. Also, the base station 3170b forms part of the RAN 3120b, which may include other base stations, elements, or devices. Each base station 3170a-3170b operates to transmit or receive wireless signals within a particular geographic region or area, sometimes referred to as a “cell.” In some embodiments, multiple-input multiple-output (MIMO) technology may be employed having multiple transceivers for each cell.

The base stations 3170a-3170b communicate with one or more of the EDs 3110a-3110c over one or more air interfaces 3190 using wireless communication links. The air interfaces 3190 may utilize any suitable radio access technology.

It is contemplated that the system 3100 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 3120a-3120b are in communication with the core network 3130 to provide the EDs 3110a-3110c with voice, data, application, Voice over Internet Protocol (VOIP), or other services. Understandably, the RANs 3120a-3120b or the core network 3130 may be in direct or indirect communication with one or more other RANs (not shown). The core network 3130 may also serve as a gateway access for other networks (such as the PSTN 3140, the Internet 3150, and the other networks 3160). In addition, some or all of the EDs 3110a-3110c may include functionality for communicating with different wireless networks over different wireless links using different wireless technologies or protocols. Instead of wireless communication (or in addition thereto), the EDs may communicate via wired communication channels to a service provider or switch (not shown), and to the Internet 3150.

Although FIG. 31 illustrates one example of a communication system, various changes may be made to FIG. 31. For example, the communication system 3100 could include any number of EDs, base stations, networks, or other components in any suitable configuration.

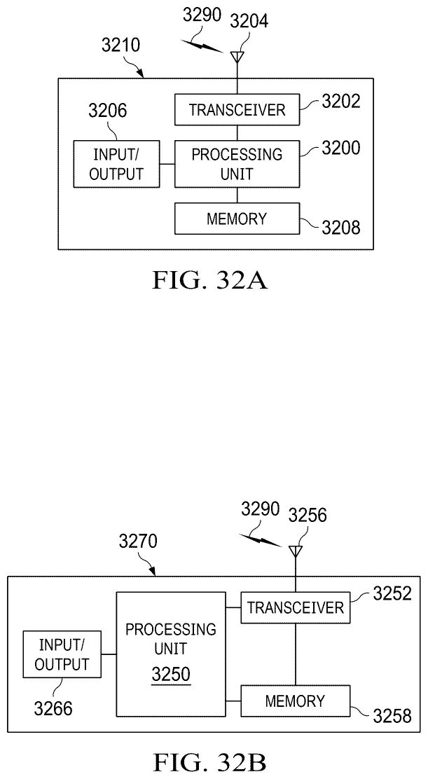

FIGS. 32A and 32B illustrate example devices that may implement the methods and teachings according to this disclosure. In particular, FIG. 32A illustrates an example ED 3210, and FIG. 32B illustrates an example base station 3270. These components could be used in the system 3100 or in any other suitable system.

As shown in FIG. 32A, the ED 3210 includes at least one processing unit 3200. The processing unit 3200 implements various processing operations of the ED 3210. For example, the processing unit 3200 could perform signal coding, data processing, power control, input/output processing, or any other functionality enabling the ED 3210 to operate in the system 3100. The processing unit 3200 also supports the methods and teachings described in more detail above. Each processing unit 3200 includes any suitable processing or computing device configured to perform one or more operations. Each processing unit 3200 could, for example, include a microprocessor, microcontroller, digital signal processor, field programmable gate array, or application specific integrated circuit.

The ED 3210 also includes at least one transceiver 3202. The transceiver 3202 is configured to modulate data or other content for transmission by at least one antenna or NIC (Network Interface Controller) 3204. The transceiver 3202 is also configured to demodulate data or other content received by the at least one antenna 3204. Each transceiver 3202 includes any suitable structure for generating signals for wireless or wired transmission or processing signals received wirelessly or by wire. Each antenna 3204 includes any suitable structure for transmitting or receiving wireless or wired signals. One or multiple transceivers 3202 could be used in the ED 3210, and one or multiple antennas 3204 could be used in the ED 3210. Although shown as a single functional unit, a transceiver 3202 could also be implemented using at least one transmitter and at least one separate receiver.

The ED 3210 further includes one or more input/output devices 3206 or interfaces (such as a wired interface to the Internet 3150). The input/output devices 3206 facilitate interaction with a user or other devices (network communications) in the network. Each input/output device 3206 includes any suitable structure for providing information to or receiving information from a user, such as a speaker, microphone, keypad, keyboard, display, or touch screen, including network interface communications.

In addition, the ED 3210 includes at least one memory 3208. The memory 3208 stores instructions and data used, generated, or collected by the ED 3210. For example, the memory 3208 could store software or firmware instructions executed by the processing unit(s) 3200 and data used to reduce or eliminate interference in incoming signals. Each memory 3208 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 32B, the base station 3270 includes at least one processing unit 3250, at least one transceiver 3252, which includes functionality for a transmitter and a receiver, one or more antennas 3256, at least one memory 3258, and one or more input/output devices or interfaces 3266. A scheduler, which would be understood by one skilled in the art, is coupled to the processing unit 3250. The scheduler could be included within or operated separately from the base station 3270. The processing unit 3250 implements various processing operations of the base station 3270, such as signal coding, data processing, power control, input/output processing, or any other functionality. The processing unit 3250 can also support the methods and teachings described in more detail above. Each processing unit 3250 includes any suitable processing or computing device configured to perform one or more operations. Each processing unit 3250 could, for example, include a microprocessor, microcontroller, digital signal processor, field programmable gate array, or application specific integrated circuit.

Each transceiver 3252 includes any suitable structure for generating signals for wireless or wired transmission to one or more EDs or other devices. Each transceiver 3252 further includes any suitable structure for processing signals received wirelessly or by wire from one or more EDs or other devices. Although shown combined as a transceiver 3252, a transmitter and a receiver could be separate components. Each antenna 3256 includes any suitable structure for transmitting or receiving wireless or wired signals. While a common antenna 3256 is shown here as being coupled to the transceiver 3252, one or more antennas 3256 could be coupled to the transceiver(s) 3252, allowing separate antennas 3256 to be coupled to the transmitter and the receiver if equipped as separate components. Each memory 3258 includes any suitable volatile or non-volatile storage and retrieval device(s). Each input/output device 3266 facilitates interaction with a user or other devices (network communications) in the network. Each input/output device 3266 includes any suitable structure for providing information to or receiving/providing information from a user, including network interface communications.

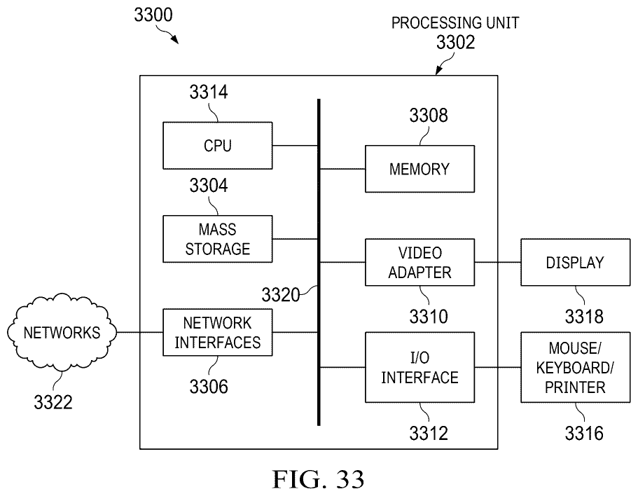

FIG. 33 is a block diagram of a computing system 3300 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 3300 includes a processing unit 3302. The processing unit includes a central processing unit (CPU) 3314, memory 3308, and may further include a mass storage device 3304, a video adapter 3310, and an I/O interface 3312 connected to a bus 3320.

The bus 3320 may be one or more of any type of several bus architectures including a memory bus or memory controller, a peripheral bus, or a video bus. The CPU 3314 may comprise any type of electronic data processor. The memory 3308 may comprise any type of non-transitory system memory such as static random access memory (SRAM), dynamic random access memory (DRAM), synchronous DRAM (SDRAM), read-only memory (ROM), or a combination thereof. In an embodiment, the memory 3308 may include ROM for use at boot-up, and DRAM for program and data storage for use while executing programs.

The mass storage 3304 may comprise any type of non-transitory storage device configured to store data, programs, and other information and to make the data, programs, and other information accessible via the bus 3320. The mass storage 3304 may comprise, for example, one or more of a solid state drive, hard disk drive, a magnetic disk drive, or an optical disk drive.

The video adapter 3310 and the I/O interface 3312 provide interfaces to couple external input and output devices to the processing unit 3302. As illustrated, examples of input and output devices include a display 3318 coupled to the video adapter 3310 and a mouse, keyboard, or printer 3316 coupled to the I/O interface 3312. Other devices may be coupled to the processing unit 3302, and additional or fewer interface cards may be utilized. For example, a serial interface such as Universal Serial Bus (USB) (not shown) may be used to provide an interface for an external device.

The processing unit 3302 also includes one or more network interfaces 3306, which may comprise wired links, such as an Ethernet cable, or wireless links to access nodes or different networks. The network interfaces 3306 allow the processing unit 3302 to communicate with remote units via the networks. For example, the network interfaces 3306 may provide wireless communication via one or more transmitters/transmit antennas and one or more receivers/receive antennas. In an embodiment, the processing unit 3302 is coupled to a local-area network 3322 or a wide-area network for data processing and communications with remote devices, such as other processing units, the Internet, or remote storage facilities.

For all the above embodiments, it should be noted that the LP-WUR, e.g., a first receiver type, and the MR, e.g., a second receiver type, may both represent a single receiver type, within the wireless device, with two modes of operation. In a first mode of operation, the wireless device can monitor for a LP-WUS whereas in the second mode of operation, the wireless device can monitor for other signal/channels, e.g., PDCCH and PDSCH.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, a removing unit or module, or a selecting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the description has been described in detail, it should be understood that various changes, substitutions and alterations may be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

1. A method implemented in a wireless device, the method comprising:
receiving configuration information from a network device, wherein the configuration information comprises a parameter for a low power wake-up signal (LP-WUS) with a first modulation format, and wherein the configuration information further comprises a monitoring duration;
monitoring for the low power wake-up signal (LP-WUS); and
responsive to detecting a first LP-WUS, monitoring for transmissions of signals with a second modulation format until an end of the monitoring duration.

2. The method of claim 1, wherein the configuration information further indicates an offset time, wherein the offset time comprises a time for the wireless device to transition from using the first modulation format to using the second modulation format, and wherein the method further comprises:
responsive to the detecting the first LP-WUS, transitioning from using the first modulation format to using the second modulation format based on the offset time.

3. The method claim 1, wherein the first modulation format comprises one of frequency shift keying (FSK) or on-off keying (OOK), and wherein the second modulation format comprises one of:
binary phased shift keying (BPSK);
quadrature phase shift keying (QPSK);
4-quadrature amplitude modulation (4-QAM);
16-QAM;
64-QAM;
256-QAM; or
Zadoff-Chu modulation.

4. The method of claim 1, wherein the parameter further comprises indication of at least one of bandwidth, data rate, or symbol rate.

5. The method of claim 1, wherein the wireless device resumes monitoring for the LP-WUS when the wireless device is unable to receive the signals with the second modulation format within the monitoring duration.

6. The method of claim 1, wherein responsive to detecting the first LP-WUS from the network device, the wireless device sets a timer, wherein upon expiry of the timer, the wireless device resumes monitoring for the LP-WUS if the wireless device did not receive a signal with the second modulation format that is associated with the wireless device.

7. The method of claim 1, wherein the first modulation format is different from the second modulation format.

8. The method of claim 1, further comprising:
stopping the monitoring for the signals with the second modulation format when the wireless device is unable to receive the signals with the second modulation format within the monitoring duration.

9. A method implemented in a base station, the method comprising:
transmitting configuration information to a wireless device, wherein the configuration information comprises a parameter for a low power wake-up signal (LP-WUS) with a first modulation format, and wherein the configuration information further comprises a monitoring duration;
transmitting the LP-WUS to the wireless device; and
transmitting a signal with a second modulation format to the wireless device during the monitoring duration.

10. The method of claim 9, wherein the first modulation format comprises one of frequency shift keying (FSK) or on-off keying (OOK).

11. The method claim 9, wherein the second modulation format comprises one of:
binary phased shift keying (BPSK);
quadrature phase shift keying (QPSK);
4-quadrature amplitude modulation (4-QAM);
16-QAM;
64-QAM;
256-QAM; or
Zadoff-Chu modulation.

12. The method of claim 9, wherein the parameter further comprises indication of at least one of bandwidth, data rate, or symbol rate.

13. The method of claim 9, wherein the first modulation format is different from the second modulation format.

14. A wireless device, comprising:
at least one processor; and
a non-transitory memory storing programming instructions that, when executed by the at least one processor, cause the wireless device to perform:
receiving configuration information from a network device, wherein the configuration information comprises a parameter for a low power wake-up signal (LP-WUS) with a first modulation format, and wherein the configuration information further comprises a monitoring duration;
monitoring for the low power wake-up signal (LP-WUS); and
responsive to detecting a first LP-WUS, monitoring for transmissions of signals with a second modulation format until an end of the monitoring duration.

15. The wireless device of claim 14, wherein the configuration information further indicates an offset time, wherein the offset time comprises a time for the wireless device to transition from the first modulation format to the second modulation format, and wherein the instructions, when executed by the at least one processor, further cause the wireless device to perform:
responsive to the detecting the first LP-WUS, transitioning from using the first modulation format to using the second modulation format based on the offset time.

16. The wireless device of claim 14, wherein the first modulation format comprises one of frequency shift keying (FSK) or on-off keying (OOK), and wherein the second modulation format comprises one of:
binary phased shift keying (BPSK);
quadrature phase shift keying (QPSK);
4-quadrature amplitude modulation (4-QAM);
16-QAM;
64-QAM;
256-QAM; or
Zadoff-Chu modulation.

17. The wireless device of claim 14, wherein the parameter further comprises indication of at least one of bandwidth, data rate, or symbol rate.

18. The wireless device of claim 14, wherein the wireless device resumes monitoring for the LP-WUS when the wireless device is unable to receive the signals with the second modulation format within the monitoring duration.

19. The wireless device of claim 14, wherein responsive to detecting the first LP-WUS from the network device, the wireless device sets a timer, wherein upon expiry of the timer, the wireless device resumes monitoring for the LP-WUS if the wireless device did not receive a signal with the second modulation format that is associated with the wireless device.

20. The wireless device of claim 14, the instructions, when executed by the at least one processor, further causing the wireless device to perform:
stopping the monitoring for the signals with the second modulation format when the wireless device is unable to receive the signals with the second modulation format within the monitoring duration.
